(19) United States
(12) Patent Application Publication
(10) Pub. No.: US 2013/0178268 A1
(43) Pub. Date: Jul. 11, 2013

(54) ELECTRONIC SYSTEM AND METHOD FOR CONDUCTING A POKER GAME

(71) Applicants: Christopher S. Wrieden, Santee, CA (US); Scott G. Reinhardt, San Diego, CA (US)

(72) Inventors: Christopher S. Wrieden, Santee, CA (US); Scott G. Reinhardt, San Diego, CA (US)

(21) Appl. No.: 13/734,665

(22) Filed: Jan. 4, 2013

Related U.S. Application Data
(60) Provisional application No. 61/583,475, filed on Jan. 5, 2012.

(51) Int. Cl. A63F 13/00

(52) U.S. Cl. CPC A63F 13/005
USPC 463/13

(57) ABSTRACT

An electronic system and method for conducting a poker game. A Texas Hold' em version involves displaying pairs of face-up, hole cards on which a player may place wagers. Odds and/or winning percentages associated with each pair of hole cards may be displayed. Common cards are revealed and the player is able to place second and third sets of wagers on any one or more of the hands based on adjusted odds and/or winning percentages. After a river card is revealed, wagers are resolved based on the identification of the highest ranking five-card poker hand formed using the hole cards in combination with the common cards. Other variations include (i) ante wagers placed before revelation of the hole cards wherein the ante wagers are based on a final hand rank; and (ii) one or more secret hands and the option to purchase insurance against the secret hand being the winning hand.

### CROSS-REFERENCES

This application claims the benefit of U.S. Provisional Patent Application No. 61/583,475 filed Jan. 5, 2012 which is incorporated herein for all purposes.

### FIELD OF THE INVENTION

The embodiments of the present invention relate to a poker game facilitated by a standalone electronic gaming device, network thereof or online system.

### BACKGROUND

The popularity of poker has swelled over the last 10 years. The popularity is at least partially attributable to the Internet and television. The Internet has allowed the masses to play poker while television has shown the masses the large pools of money which may be won and the fame which may be achieved. The most popular poker game is Texas Hold' em. Texas Hold' em is offered in most poker rooms, card rooms and online poker websites and has even spawned live casino table games pitting players against the house.

Despite the popularity, there lacks a single player, electronic version of Texas Hold' em (and other poker games) which captures the attractive features of Texas Hold' em. Advantageously, the electronic version should be intuitive and capitalize on the popular features of Texas Hold' em.

### SUMMARY

Accordingly, one electronically-implemented method of conducting a Texas Hold' em poker game according to the embodiments of the present invention involves revealing on a display multiple hands each comprising pairs of face-up, hole cards on which the player may place a first set of wagers. Odds and/or winning percentages associated with each pair of hole cards being the winning hand may be displayed proximate to each of said multiple hands. Potential payouts based on the odds and/or winning percentages and wager amounts may also be displayed. Next, three flop cards are revealed and the player is able to place a second set of wagers on any one or more of the multiple hands. Adjusted odds and/or winning percentages are calculated (based on the revealed flop cards) and displayed and used for the second set of wagers. Next, a turn card is revealed and the player is able to place a third set of wagers on any one or more of the multiple hands. Adjusted odds and/or winning percentages are calculated (based on the revealed turn card) and displayed and used for the third set of wagers. Lastly, a river card is revealed and the player wagers are resolved based on the highest ranking poker hand formed of two hole cards in combination with the three flop cards, turn card and river card.

Other embodiments include (i) ante wagers placed before revelation of the hole cards wherein the ante wagers are based on a final hand rank independent of whether the hand is the winning hand; and (ii) one or more blind/secret hands and the option to purchase insurance against the blind/secret hand being the winning hand.

The embodiments of the present invention are well-suited for electronic gaming devices and networks thereof and online systems. Online versions may be accessed using a computer terminal (e.g., desktop or PC) or hand-held device (e.g., smart phone). Live tables may also be used to facilitate live play of the poker variants described herein.

One benefit of the embodiments of the present invention is that bluffing and bets designed to cause players to fold due to “risk” are eliminated. Instead, the player's ability to identify the hand most likely to be the “winning hand” is a primary object of the game. Players can change their mind as the common cards are revealed and place bets on other hands as the odds and/or winning percentages are adjusted. From the start, players are given information in which to fully understand their risk, and the payouts associated for taking such risks.

Other variations, embodiments and features of the present invention will become evident from the following detailed description, drawings and claims.

### BRIEF DESCRIPTION OF THE DRAWINGS

FIG. 1 illustrates a block diagram of a standalone electronic gaming device for conducting a poker game according to the embodiments of the present invention;

FIG. 2 illustrates a block diagram of a wireless system accessible by a mobile device for conducting a poker game according to the embodiments of the present invention;

FIGS. 3A-3H illustrate screen shots of a poker game conducted according to a first embodiment of the present invention;

FIGS. 4A-4K illustrate screen shots of a poker game according to a second embodiment of the present invention;

FIGS. 5A-5J illustrate screen shots of a poker game according to a third embodiment of the present invention; and

FIG. 6 illustrates a flow chart detailing one method of conducting a Texas Hold'em poker game according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would normally occur to one skilled in the relevant art and having possession of this disclosure, are to be considered within the scope of the invention claimed.

While the following detailed description focuses on the poker game of Texas Hold' em, the embodiments of the present invention are also applicable to other poker games such as Omaha, Stud and others and variations thereof.

Conventional Texas Hold' em is a game played as follows: (i) two or more players place blind wagers; (ii) each player is dealt two face-down hole cards; (iii) first betting round occurs; (iv) three flop cards dealt face up; (v) second round of betting occurs; (vi) turn card dealt face up; (vii) third round of betting occurs; (viii) river card dealt face up; (ix) fourth and final round of betting occurs; (x) player holding highest ranking poker hand formed from the combination of the hole cards and five common cards is awarded the pot. The winning hand is formed of the five best cards from the combination of the two hole cards and five common cards (i.e., three flop cards, one turn card and one river card).

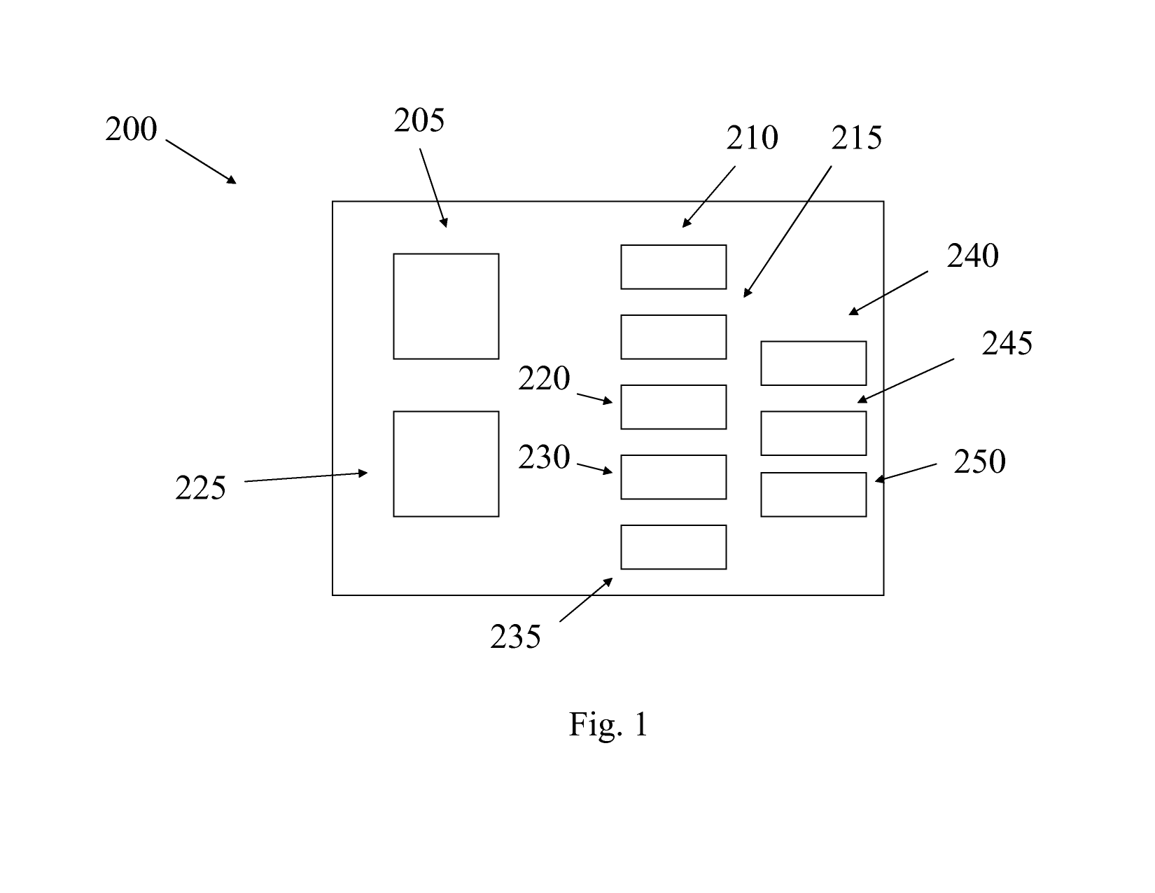

A first embodiment of the present invention is facilitated by an electronic gaming device whereby a single player plays one or more hands against the device's processor as described herein. A block diagram of the electronic gaming device 200 is shown in FIG. 1. The exemplary electronic gaming device 200 may include a central processing unit (CPU) also deemed a processor 205 which controls the electronic gaming device 200 based on instructions stored in program read-only memory (ROM) 210 and pay table ROM 215. Program ROM 210 stores executable instructions related to the operation of the gaming device and which are generally permanent. The executable instructions may include a random number generator module or a random number generator may be a separate module in communication with the processor. CPU 205 may be connected to a video controller 220 which provides output to one or more video displays 225. Similarly, an audio controller 230 provides audio output as dictated by the CPU 205 through speakers 235. The aforementioned components, and others, may be attached to a circuit board forming a motherboard. In another embodiment, the electronic gaming device is communicatively linked to a central game server which allows players to select from a number of games via the electronic gaming device 200. In such an embodiment, one or more processors integrated into the central server control the gaming device 200 based on instructions stored in program read-only memory.

A user interface 240 may respond to buttons on button panel or display incorporating touch screen technology or any other devices providing means for users to communicate with, and instruct, the electronic gaming device 200. Wager memory 245 stores an amount of money/credits deposited into the electronic gaming device 200 by a player and specific wager information related to each play of the electronic gaming device 200. Payout system 250 includes a coupon printer or similar device for receiving money/coupon from the electronic gaming device 200.

Those skilled in the art will recognize that the configuration and features of the electronic gaming device 200 disclosed herein are exemplary and may be altered in any number of ways without impacting the embodiments of the present invention.

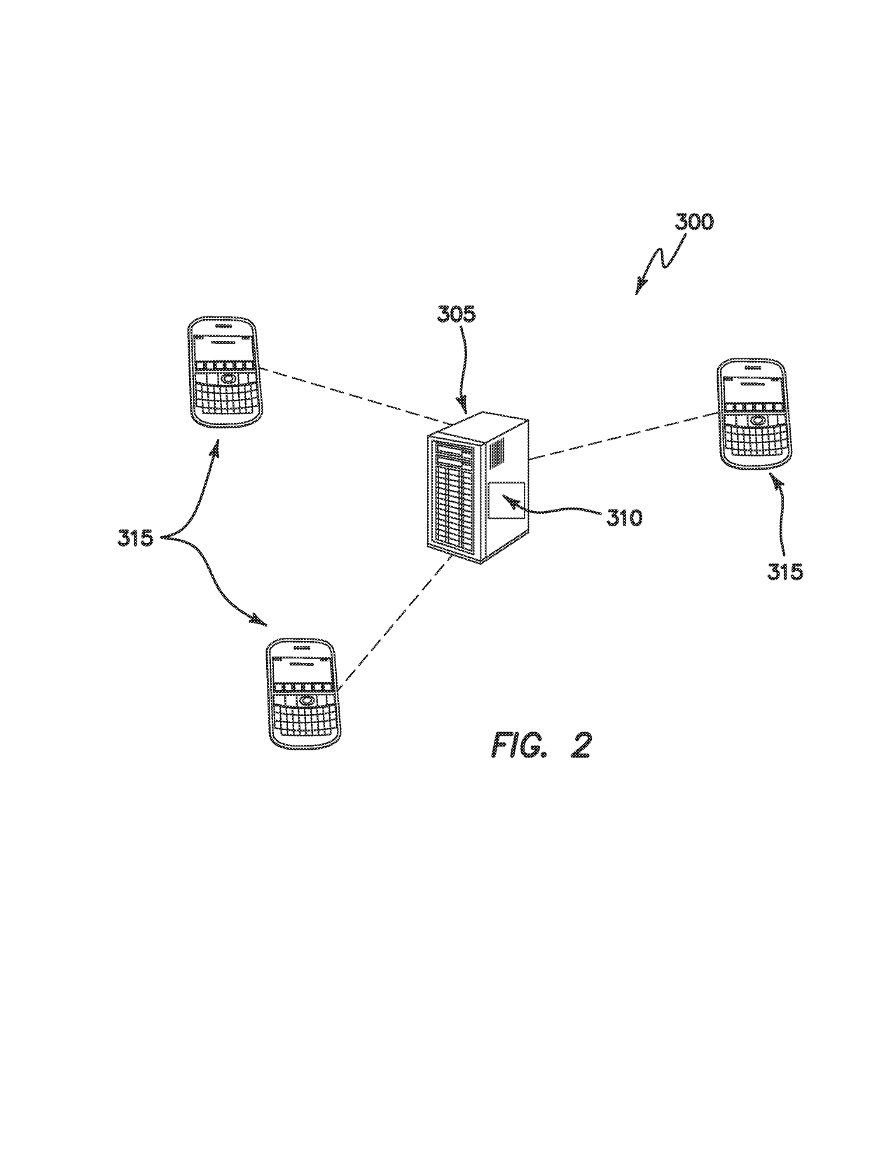

FIG. 2 shows a block diagram of a wireless system 300 which may be used to facilitate remote play of the poker games according to the embodiments of the present invention. The wireless system 300 comprises a game server 305, including one or more processors 310 running game software, and remote devices (e.g., smart phones) configured to access said game server 305 facilitating game play on the remote devices 315.

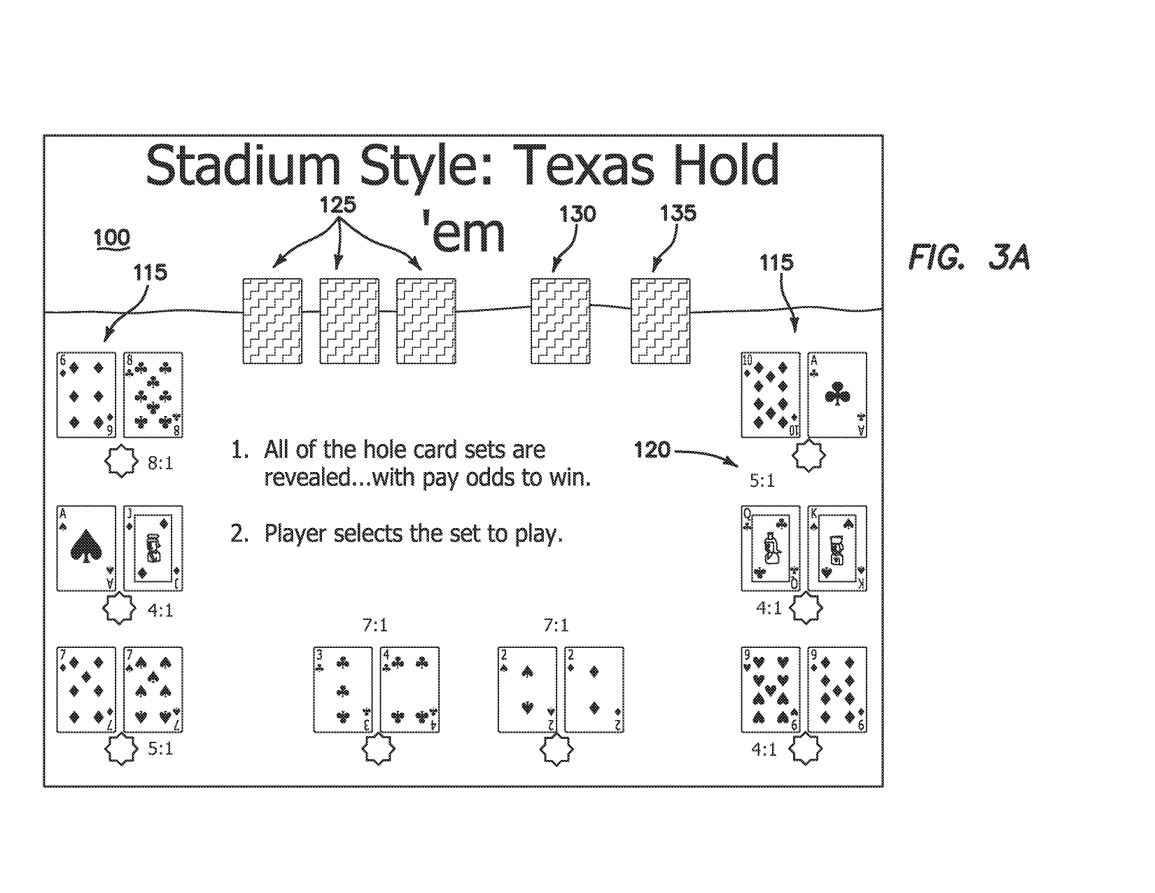

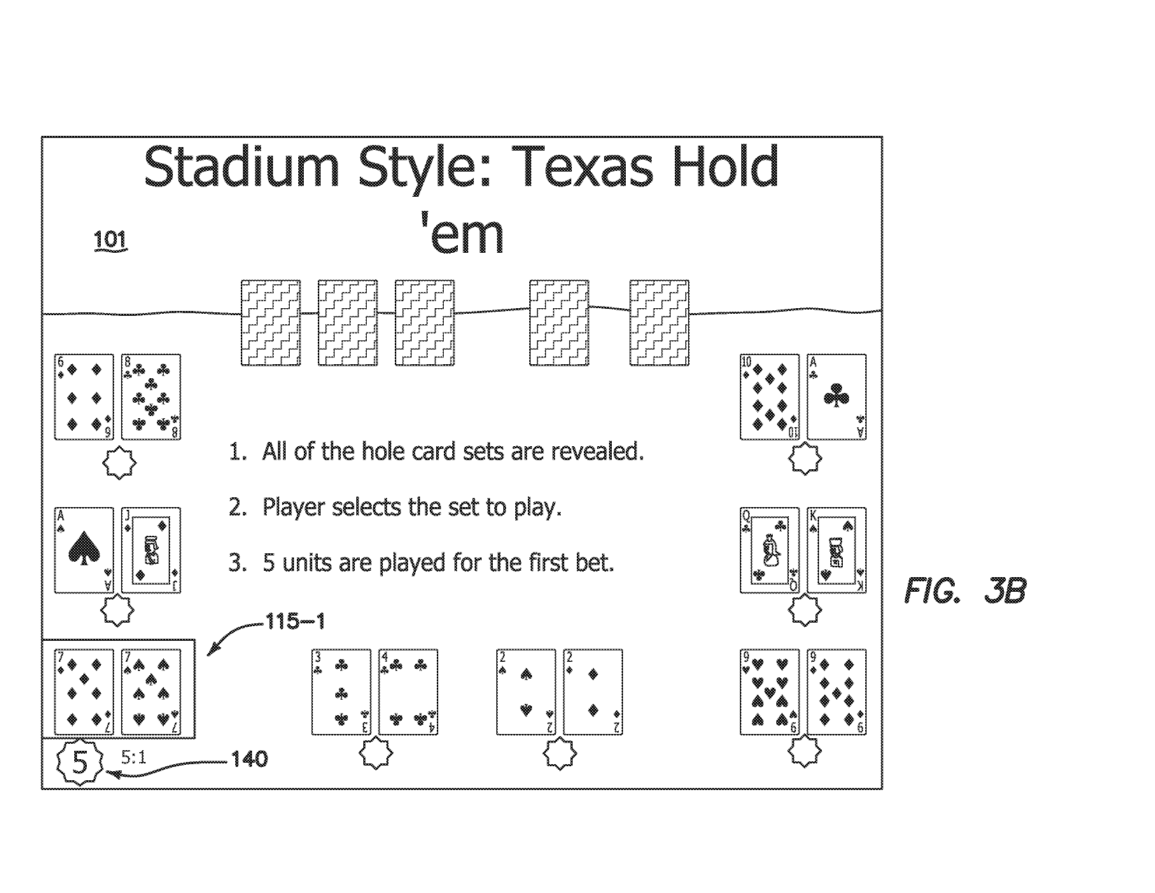

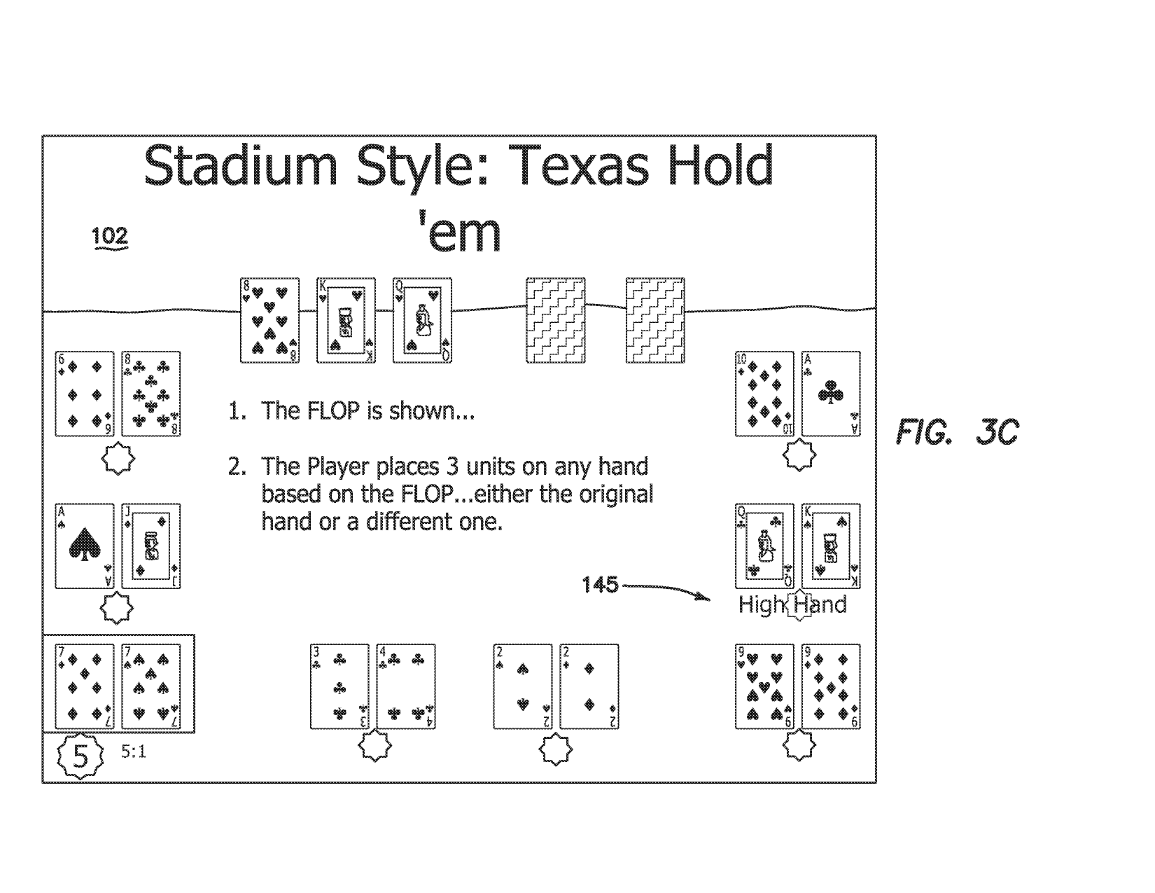

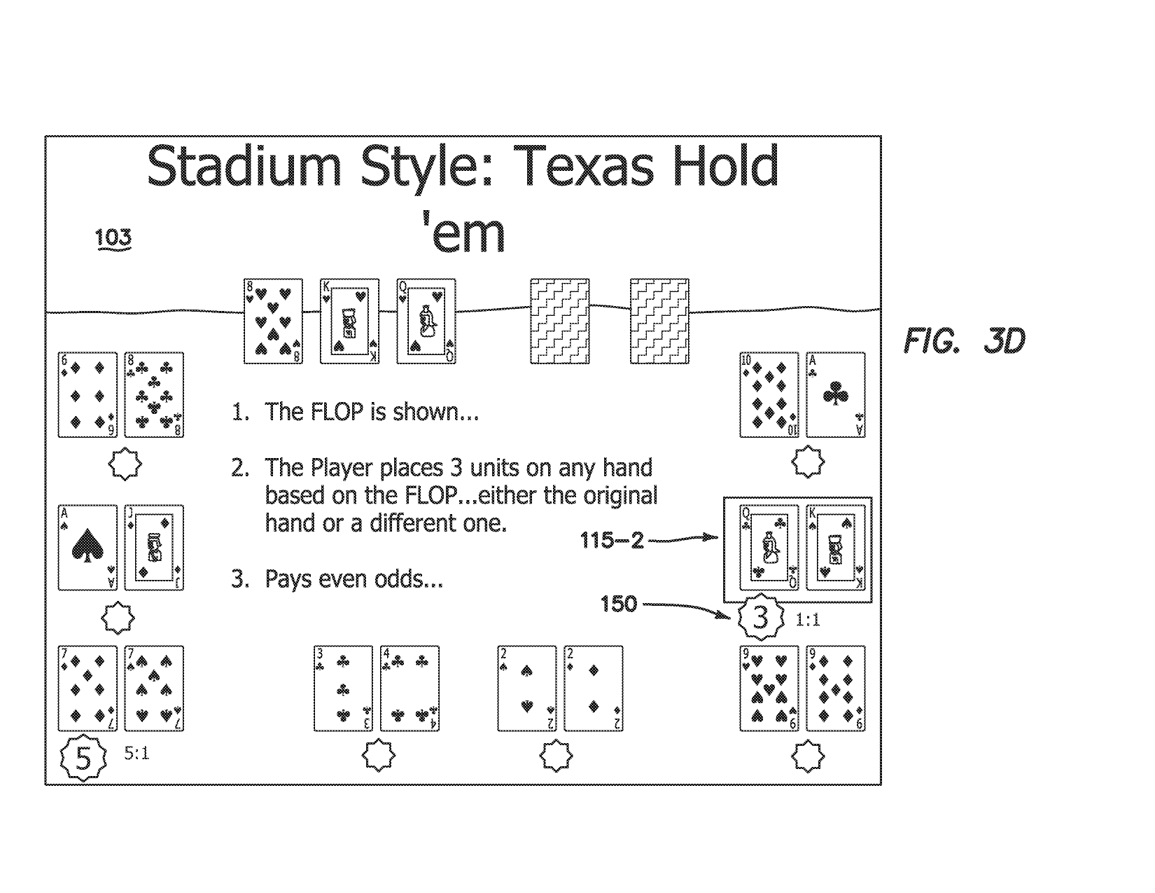

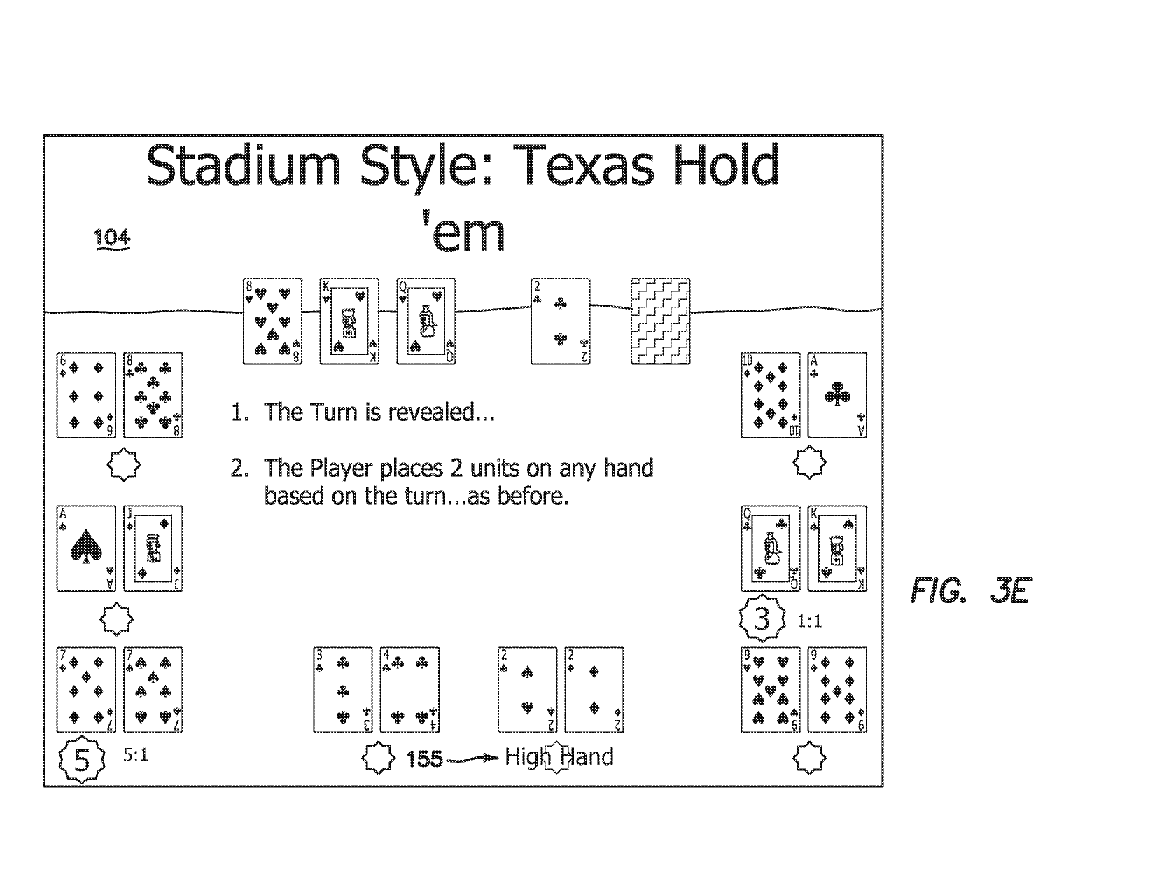

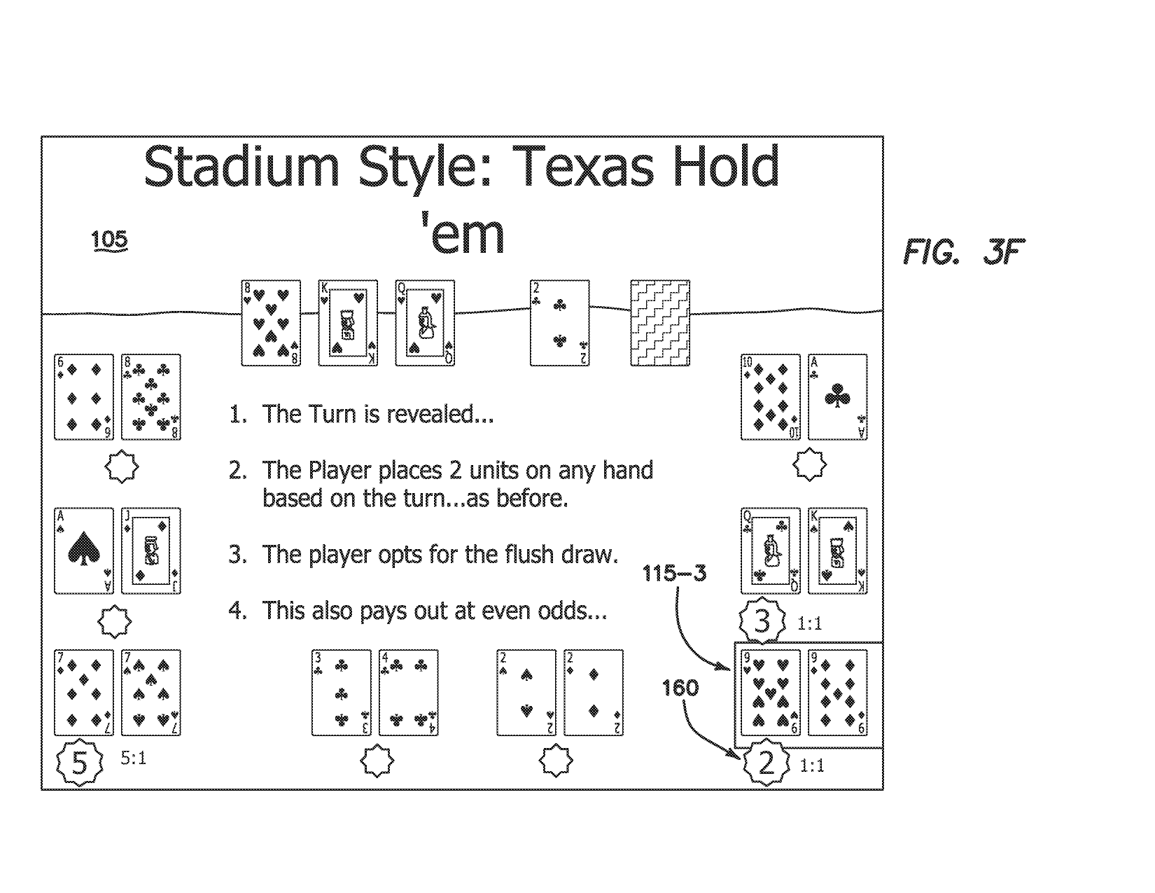

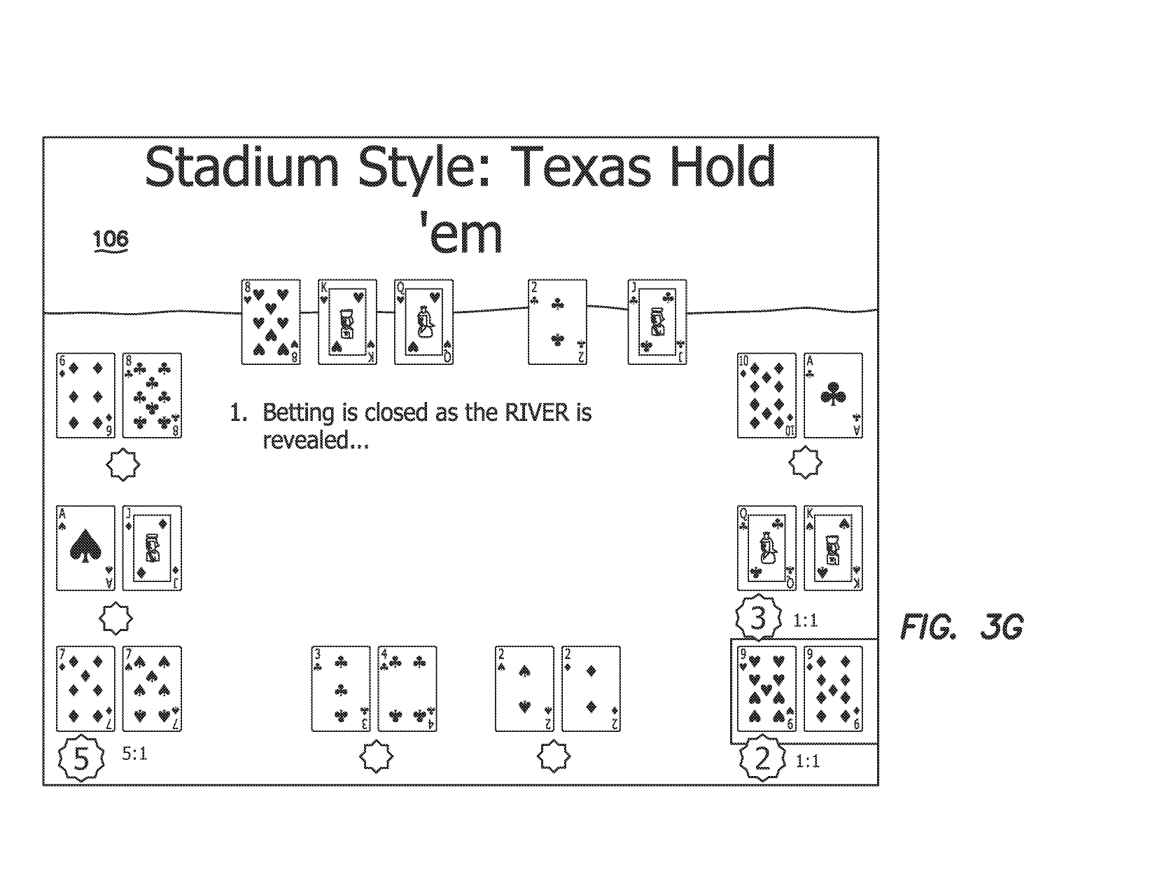

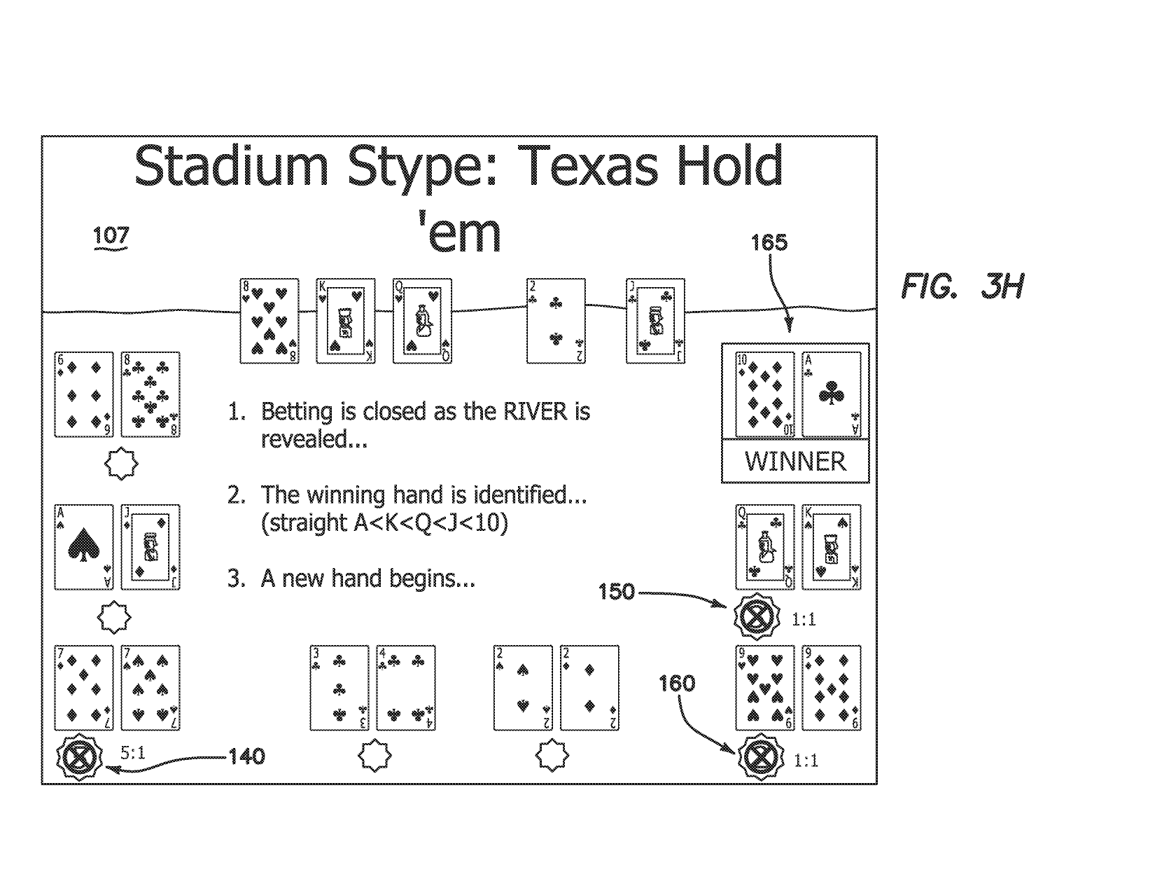

FIGS. 3A-3H show screen shots of a Texas Hold' em poker game conducted according to a first embodiment of the present invention. FIG. 3A is a screen shot 100 showing eight pairs of face-up, hole cards 115 with corresponding wager odds 120, face-down, flop cards 125, face-down, turn card 130 and face-down, river card 135. From screen shot 100, the player selects one or more pairs of face-up, hole cards 115 to wager upon. FIG. 3B is a screen shot 101 showing that the player has placed a $5 wager 140 on the pair of hole-cards 115-1 comprising a pair of 7s, namely the 74 ♦ and 74 [symbol] . FIG. 3C is a screen shot 102 showing the three flop cards 125 revealed and a current high hand indication 145. The current high hand indication 145 notifies the player that the identified pair of hole cards at this stage of the poker game has the highest rank (two pair as shown) and thus best chance of being the winning poker hand. FIG. 3D is a screen shot 103 showing a second $3 wager 150 on the pair of hole cards 115-2 comprising the Q [symbol] and K [symbol] . FIG. 3E is a screen shot 104 showing the turn card 130 revealed and a current high hand indication 155. FIG. 3F is a screen shot 105 showing a third $2 wager 160 on the pair of hole cards 115-3 comprising a pair of 9s, namely the 9 ♡ and 9 ♦. FIG. 3G is a screen shot 106 showing the river card 135 revealed. FIG. 3H is a screen shot 107 showing a winning hand indication 165. Wagers 140, 150 and 160 now appear as losing wagers since none of the poker hands had the highest rank.

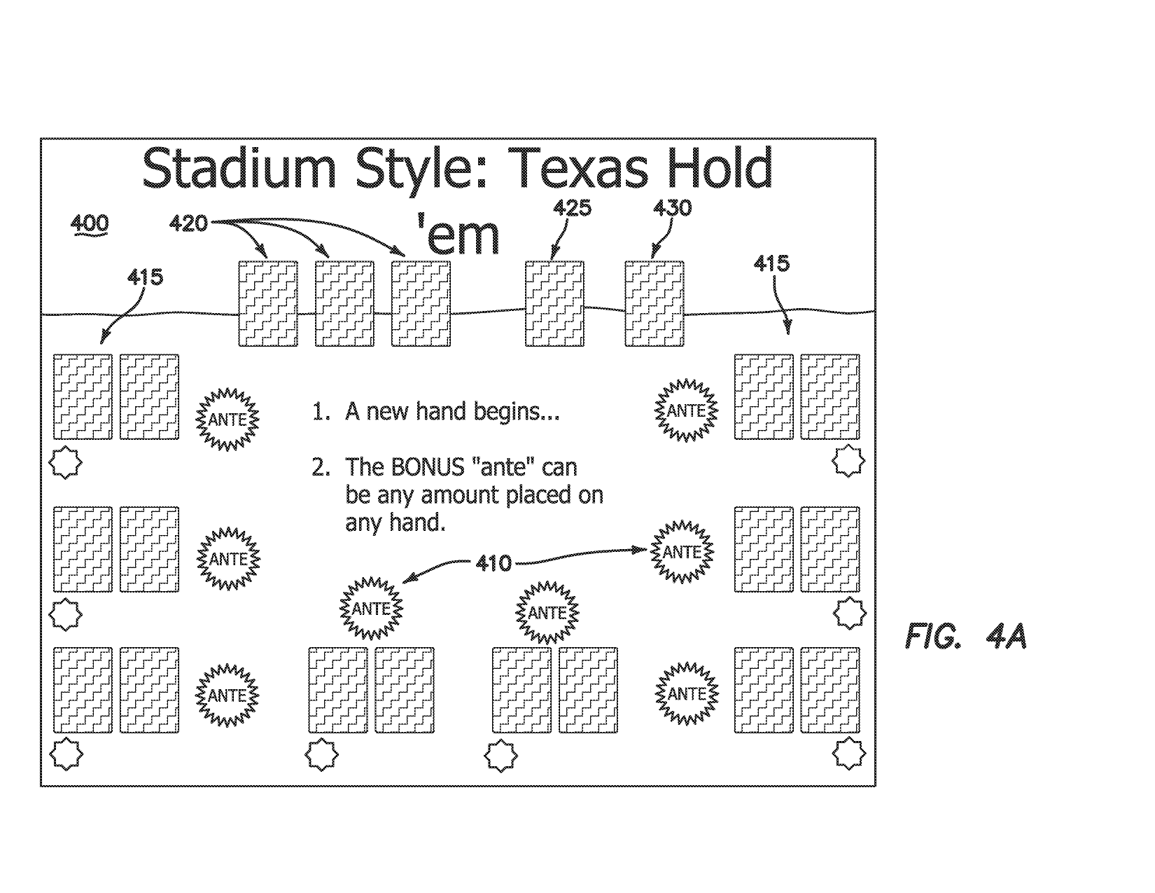

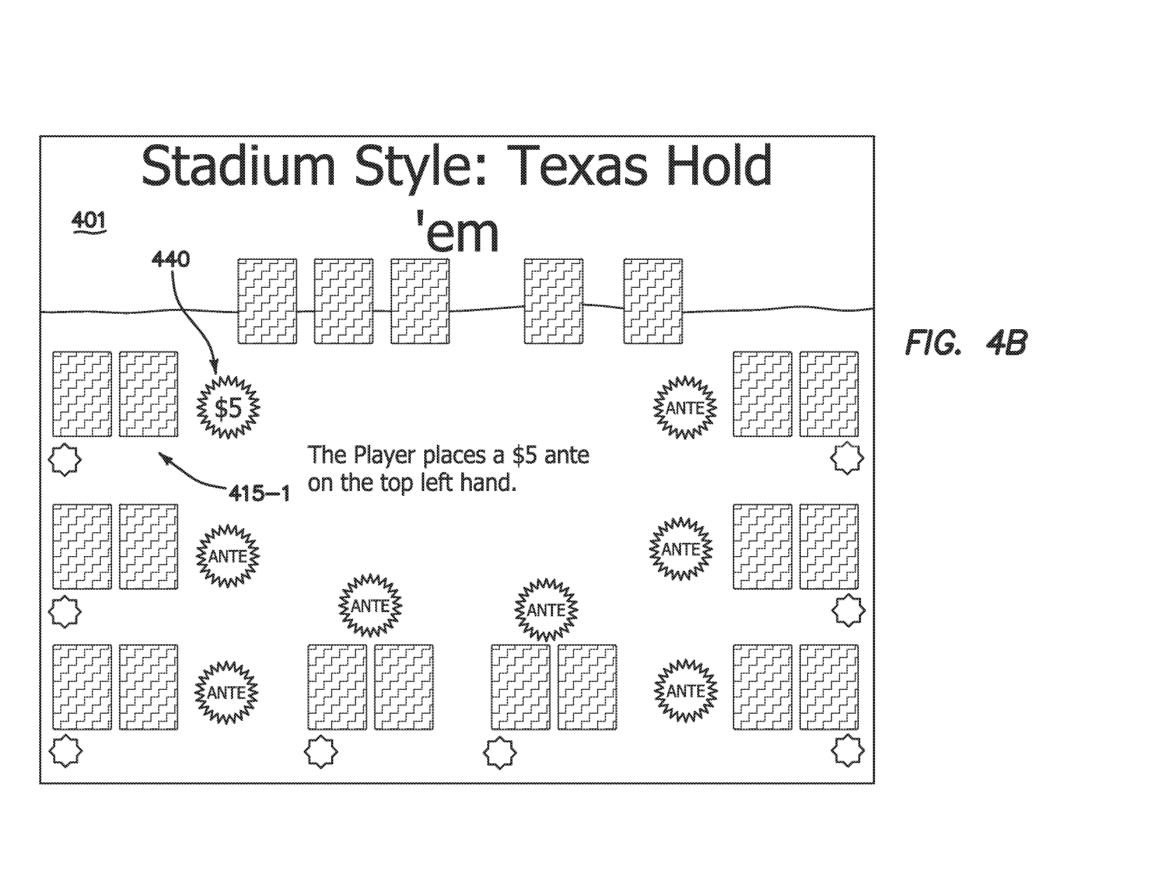

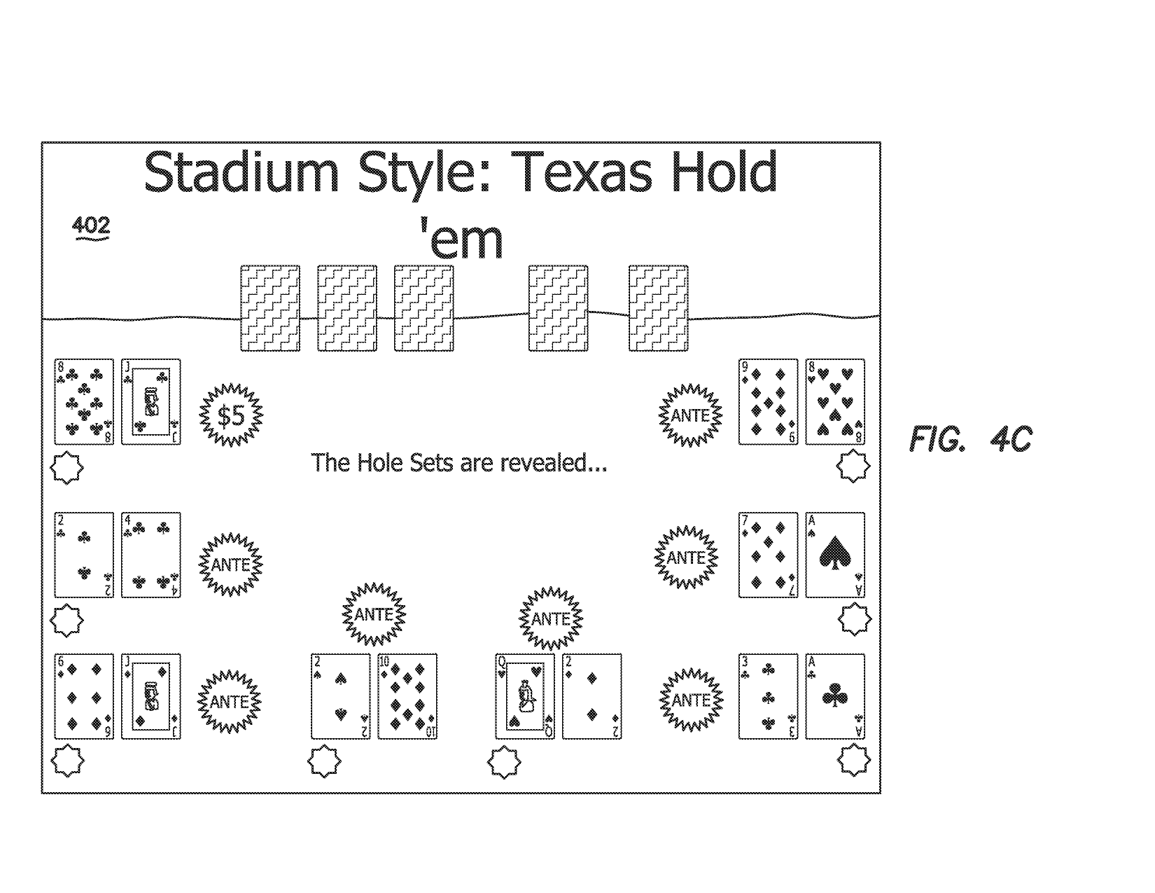

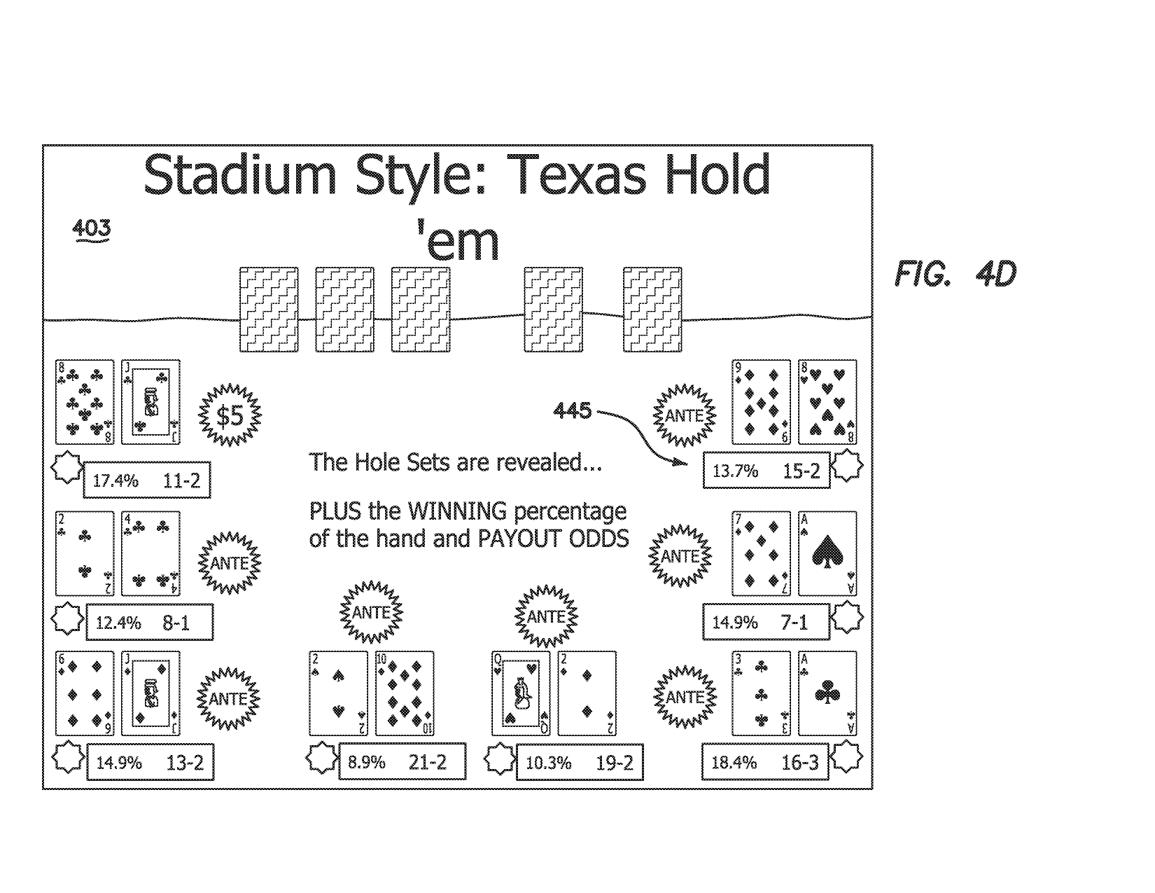

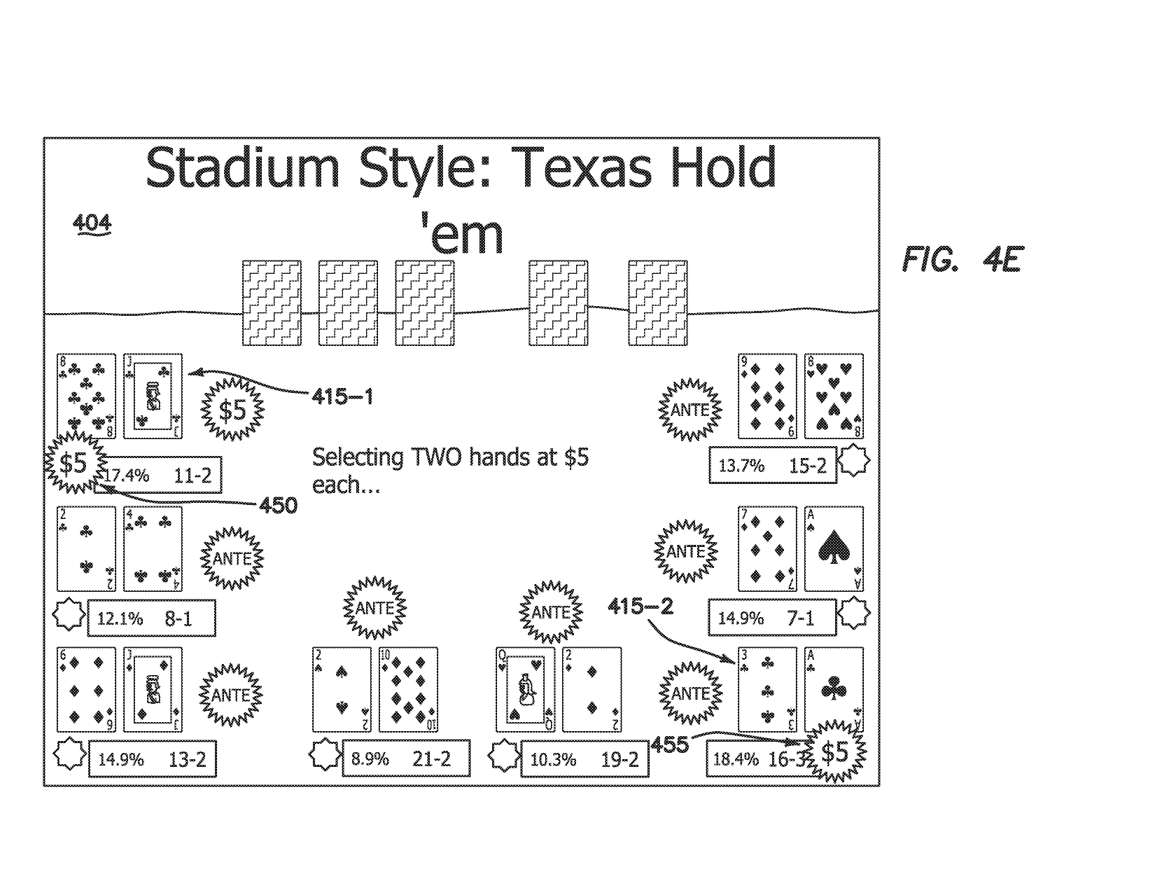

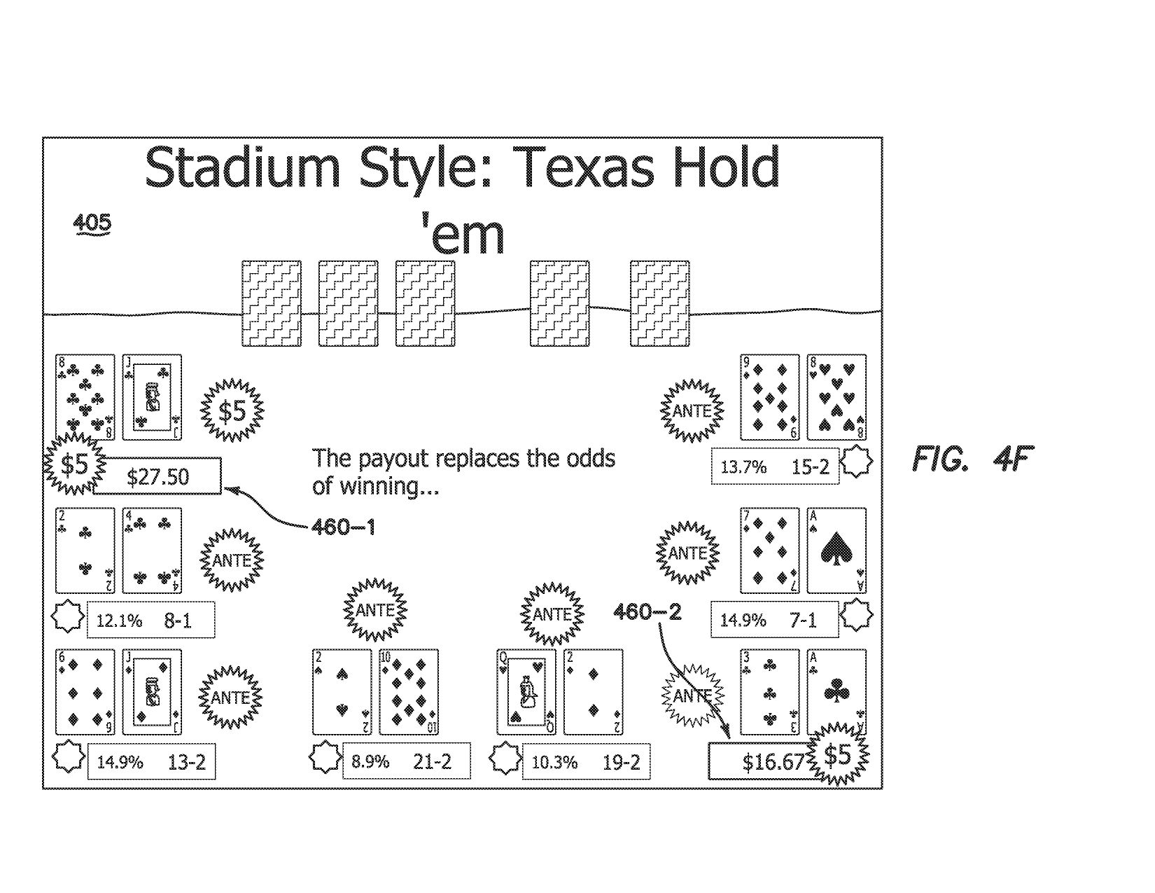

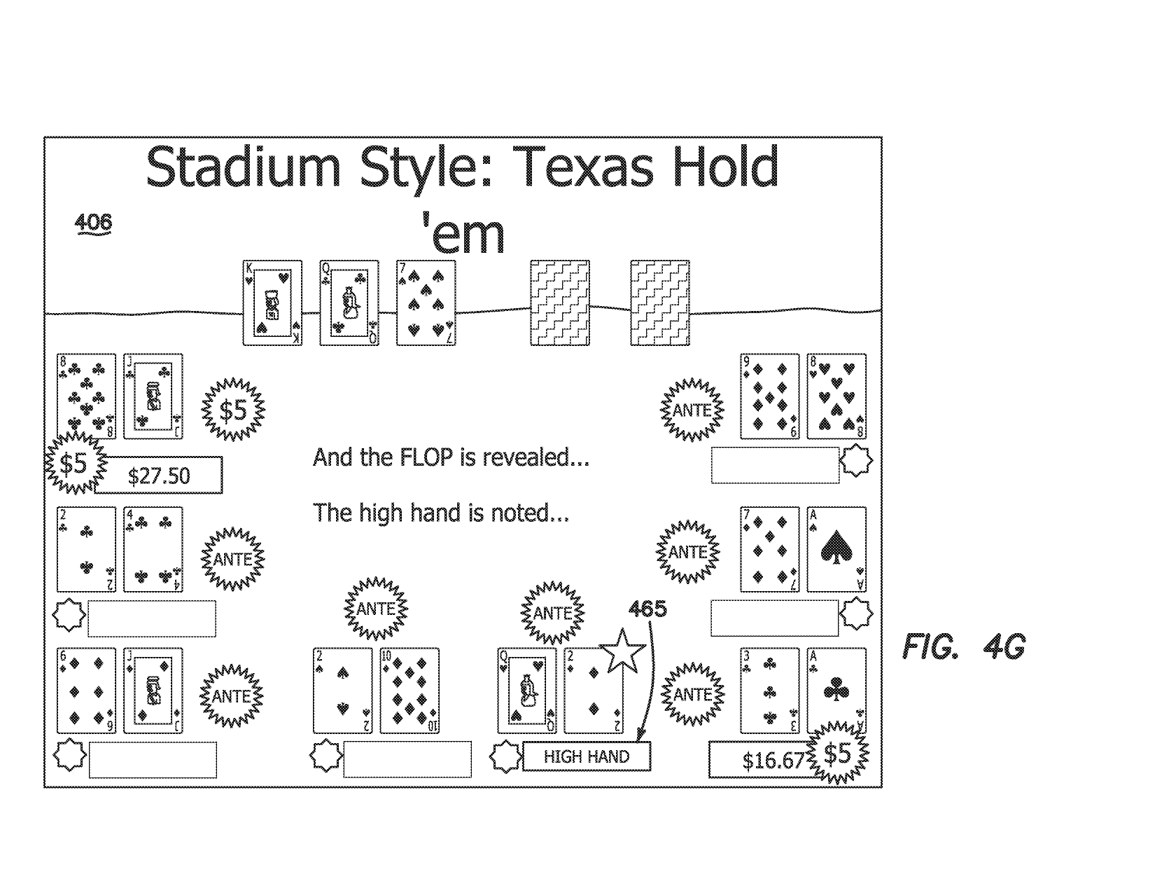

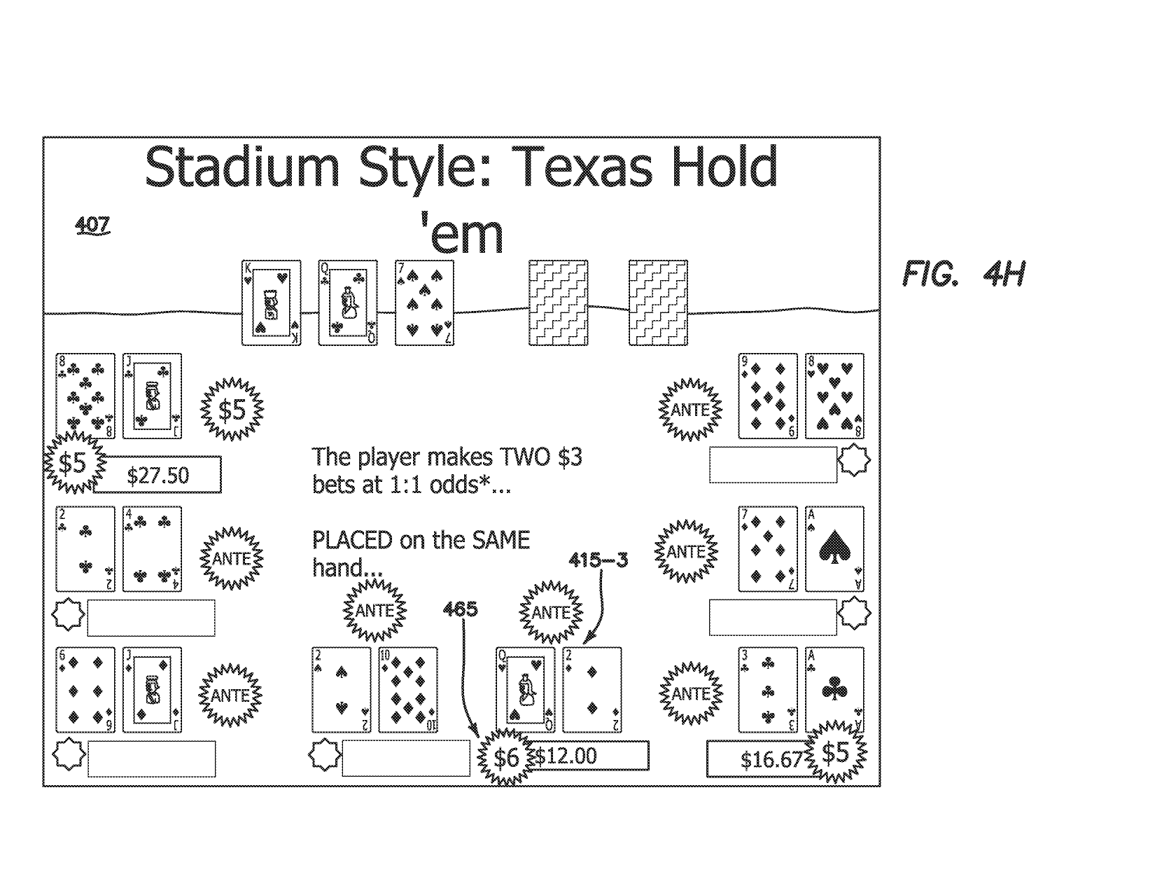

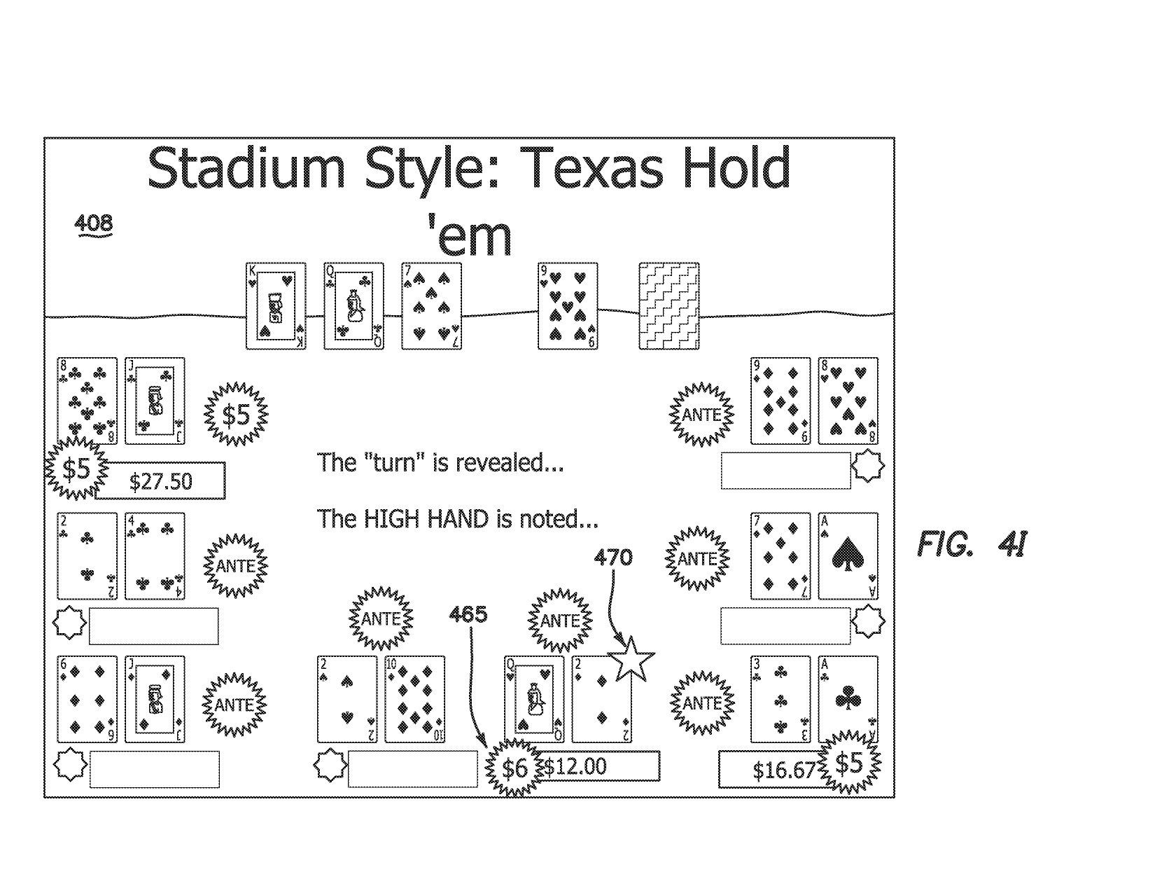

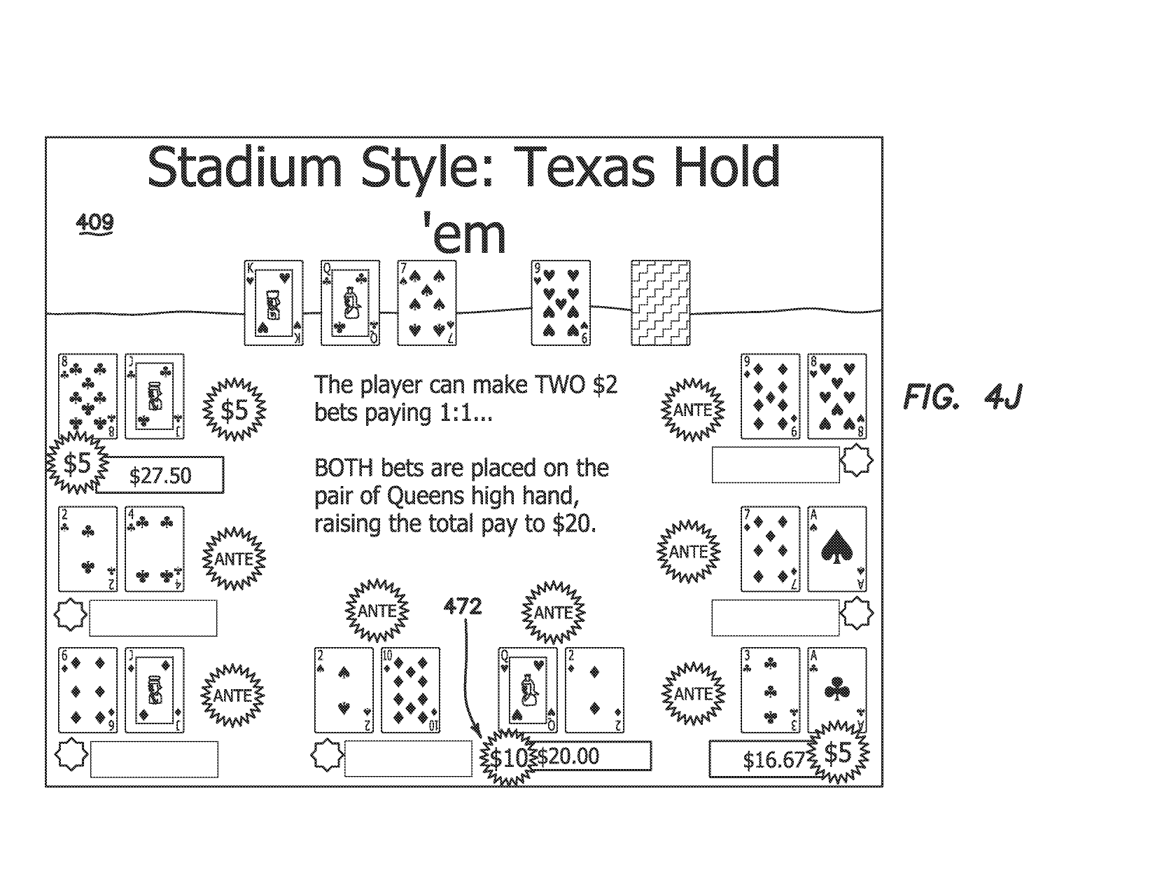

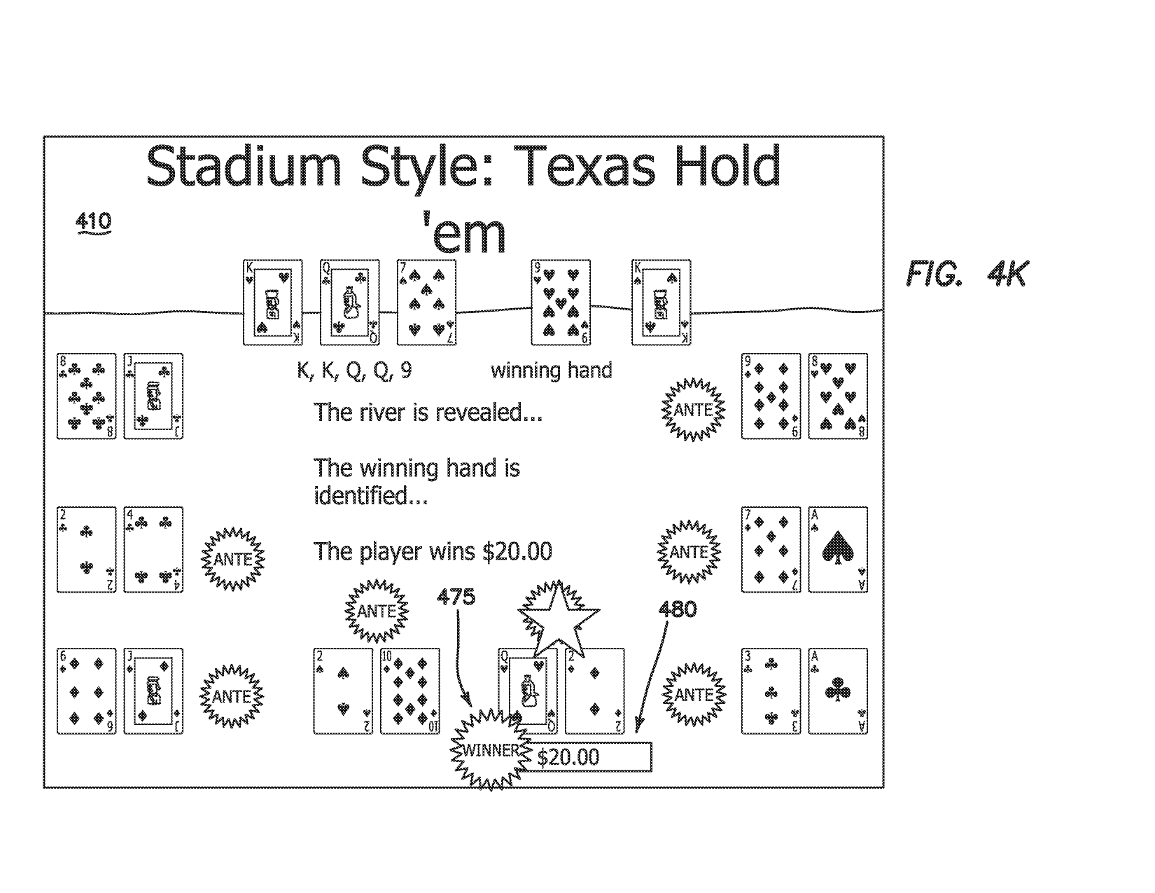

FIGS. 4A-4K illustrate screen shots of a Texas Hold' em poker game according to a second embodiment of the present invention. FIG. 4A is a screen shot 400 showing ante space 410, eight pairs of face-down, hole cards 415, along with face-down, flop cards 425, face-down, turn card 430 and face-down, river card 435. From screen shot 400, the player selects one or more pairs of face-down, hole cards on which to place an ante. FIG. 4B is a screen shot 401 showing that the player has placed a $5 ante wager 440 on the pair of hole cards 415-1. The ante wager 440 is a wager on the ultimate rank of the poker hand formed with the two selected face-down hole cards 415-1 in combination with the flop cards 425, turn card 430 and river card 435. The ante wager 440 is paid independent of whether the one or more hands receiving the ante wager win or lose. An ante wager pay table defines a minimum hand rank (e.g., 2 pair) and a maximum hand rank (e.g., Royal Flush) with increasing payouts therebetween. FIG. 4C is a screen shot 402 showing the hole cards 415 revealed. FIG. 4D is a screen shot 403 showing corresponding hand odds and wager payouts 445. FIG. 4E is a screen shot 404 showing that the player has placed a $5 wager 450 on the pair of hole cards 415-1 comprising the J [symbol] and 8 [symbol] and a $5 wager 455 on the pair of hole cards 415-2 comprising the A [symbol] and 3 [symbol] . FIG. 4F is a screen shot 405 showing potential payouts 460-1, 460-2 representative of the wagers 450, 455. FIG. 4G is a screen shot 406 showing the three flop cards 425 revealed and a current high hand indication 465 FIG. 4H is a screen shot 407 showing the player has placed two $3 wagers 465 on the same pair of hole cards 415-3 comprising the Q ♡ and 2 ♦. FIG. 41 is a screen shot 408 showing the turn card 430 revealed and a high hand indicator 470. FIG. 4J is a screen shot 409 showing the player has placed two $2 wagers on the same pair of hole cards 415-3 comprising the Q ♡ and 2 ♦ resulting in a $10 total wager 472. FIG. 4K is a screen shot 410 showing the river card 435 revealed and the winning hand 475 identified and associated payout 480 based on the wagers. The ante wager 440 is not a winning wager since the hole cards 425-1 in combination with flop cards, turn card and river card failed to reach the minimum poker hand paid pursuant to the ante wager pay table (e.g., 2 pair).

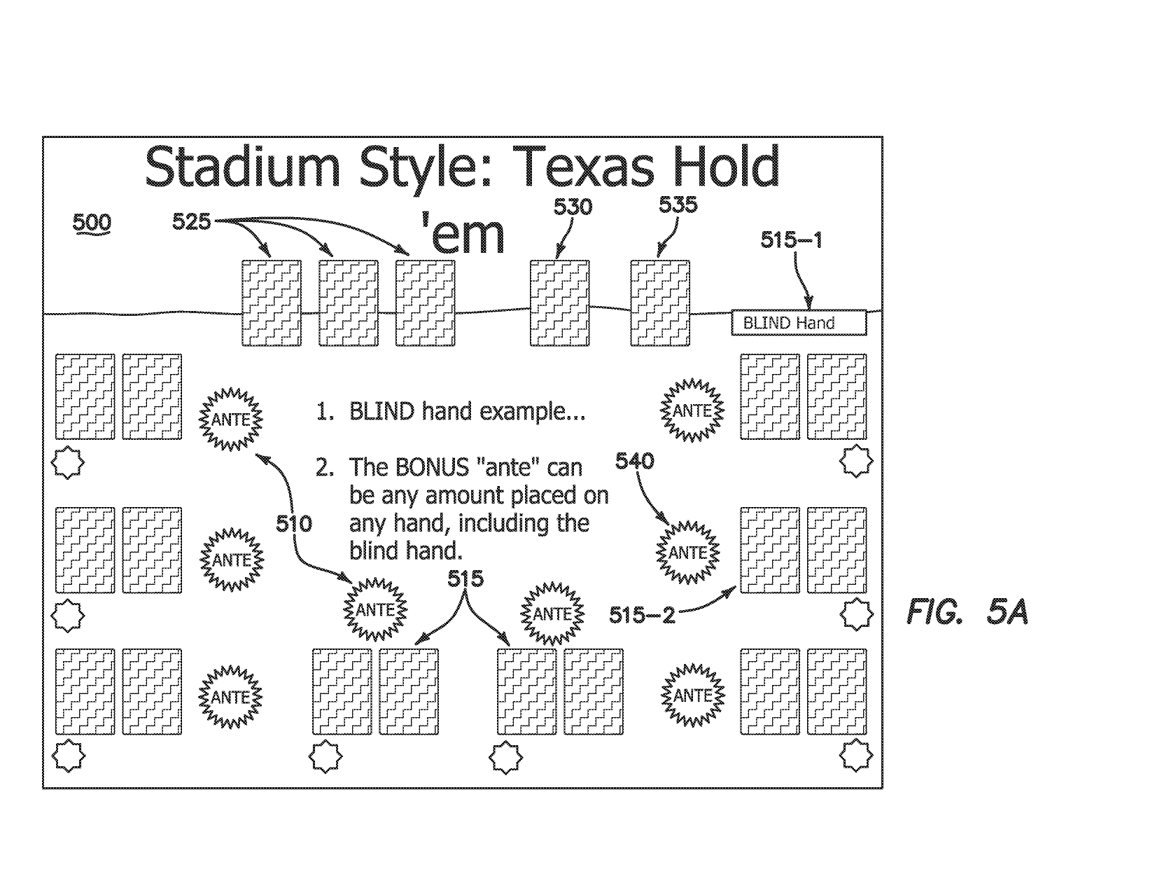

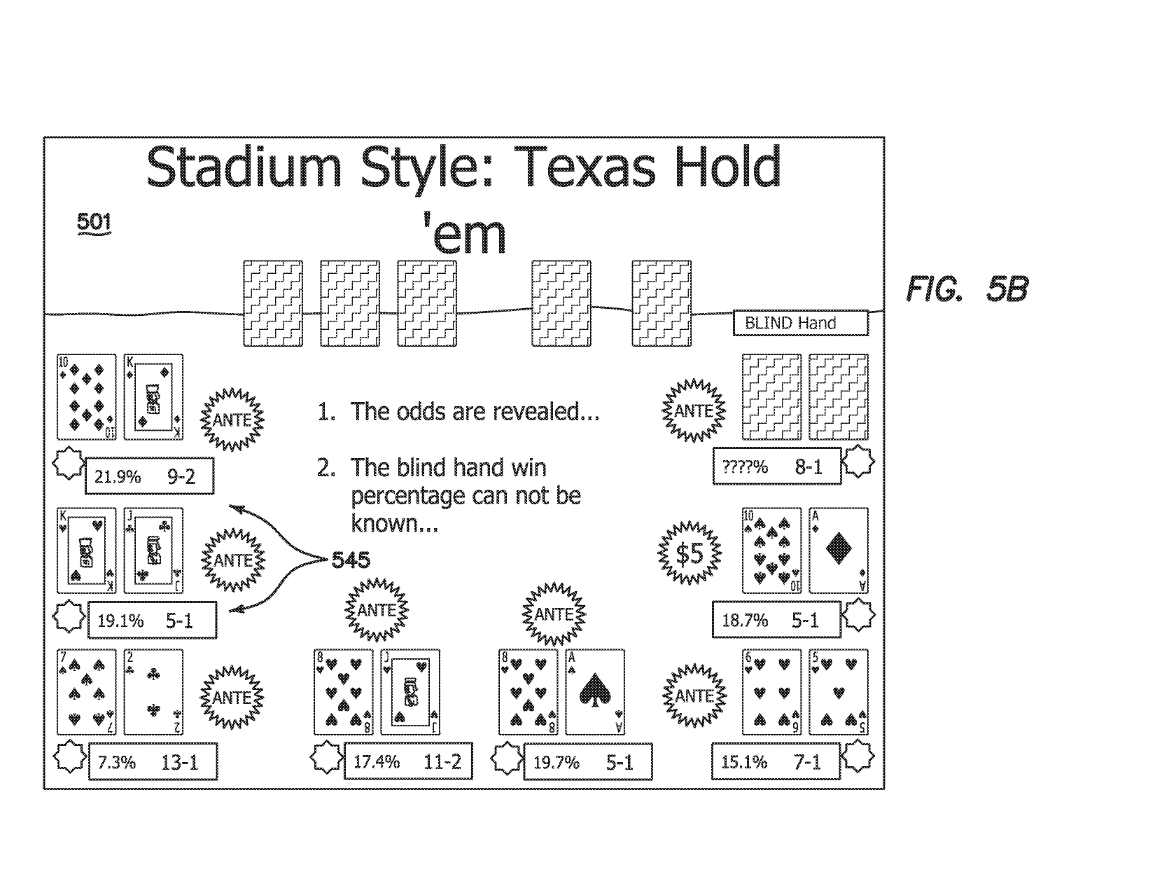

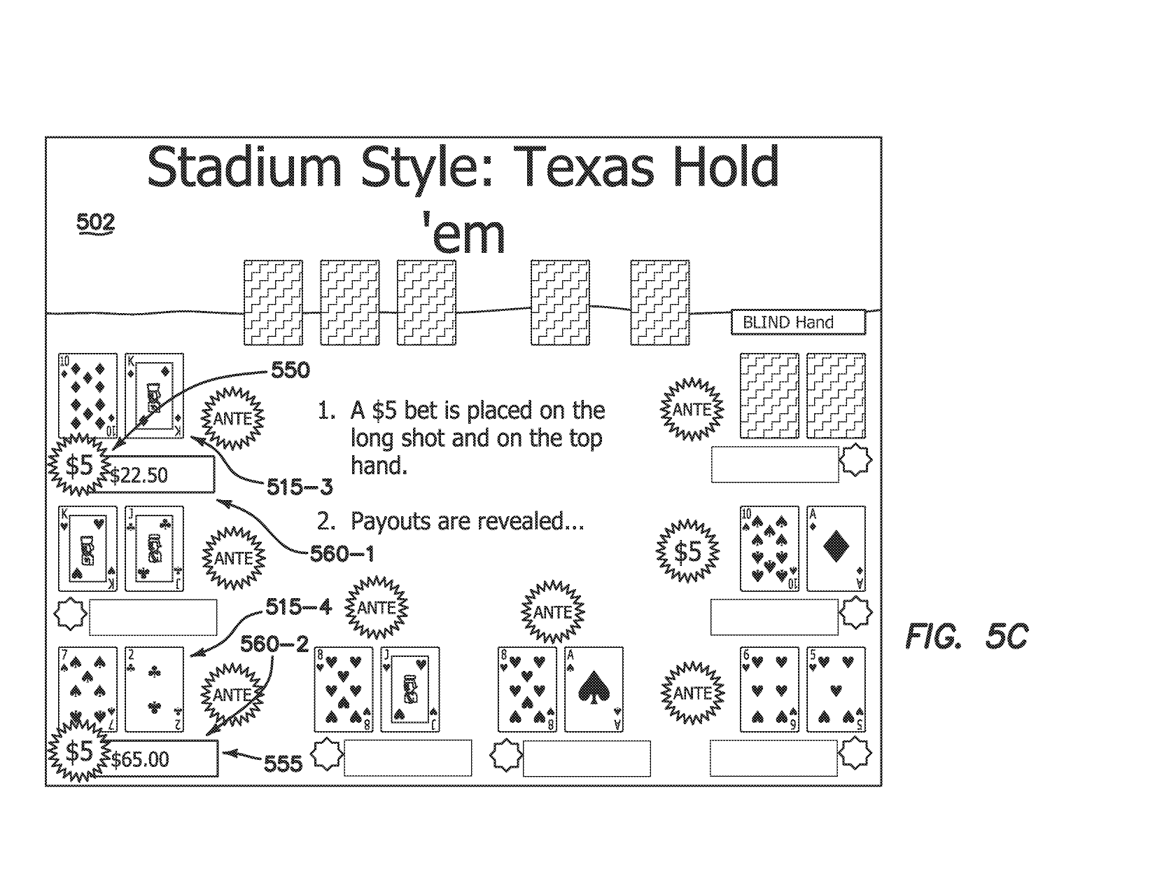

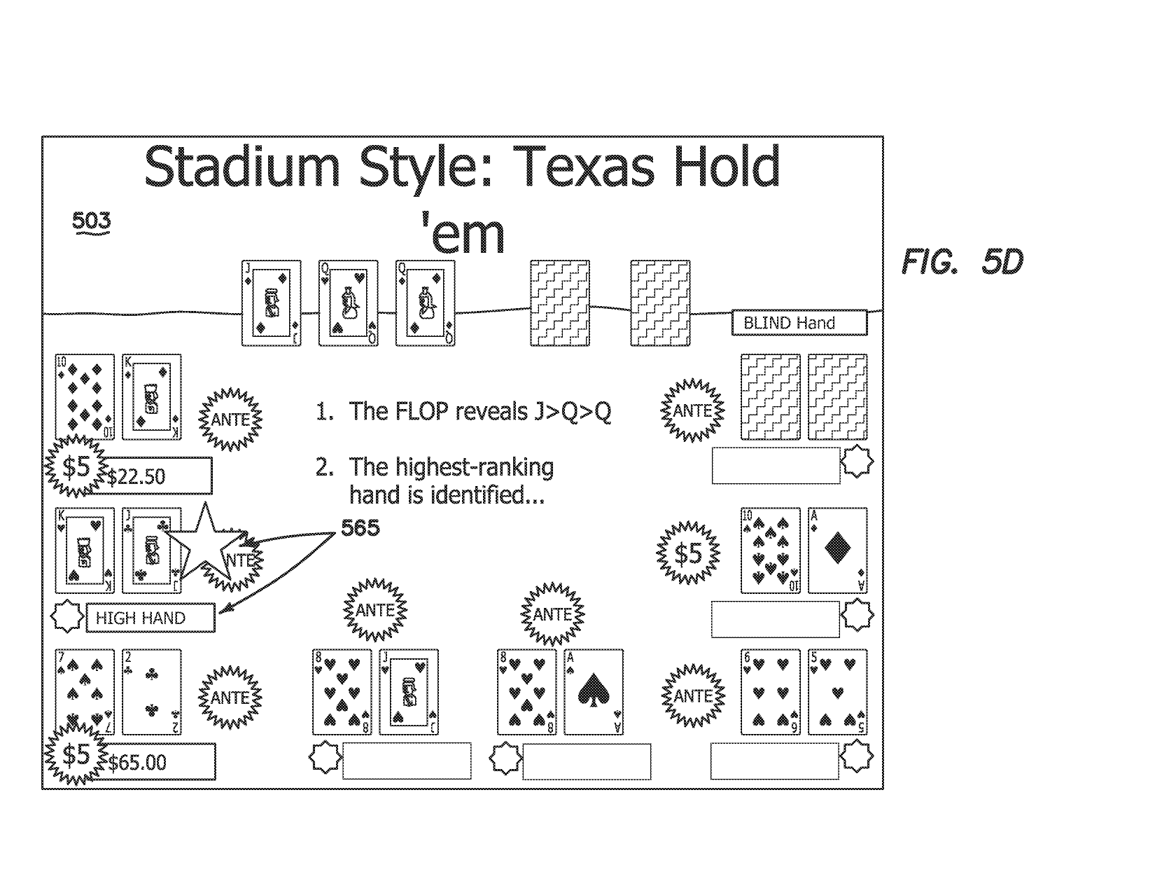

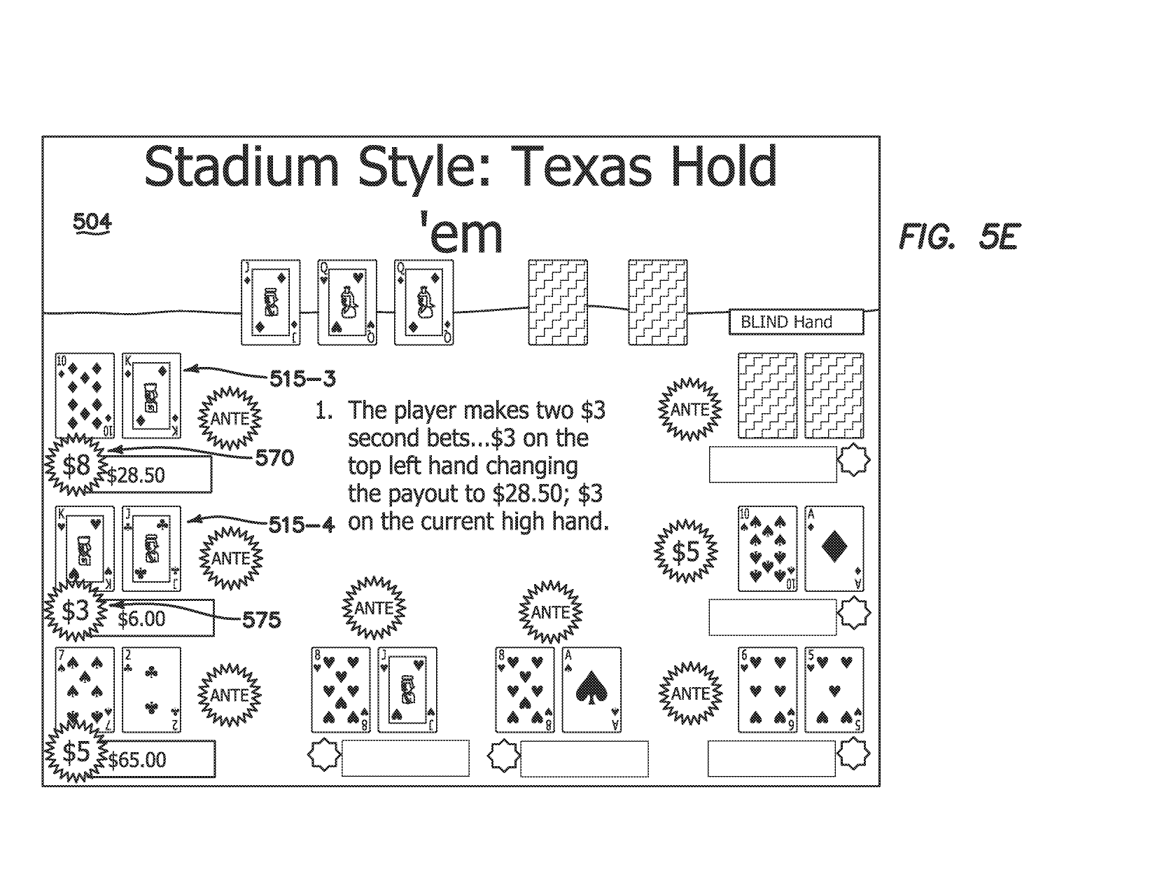

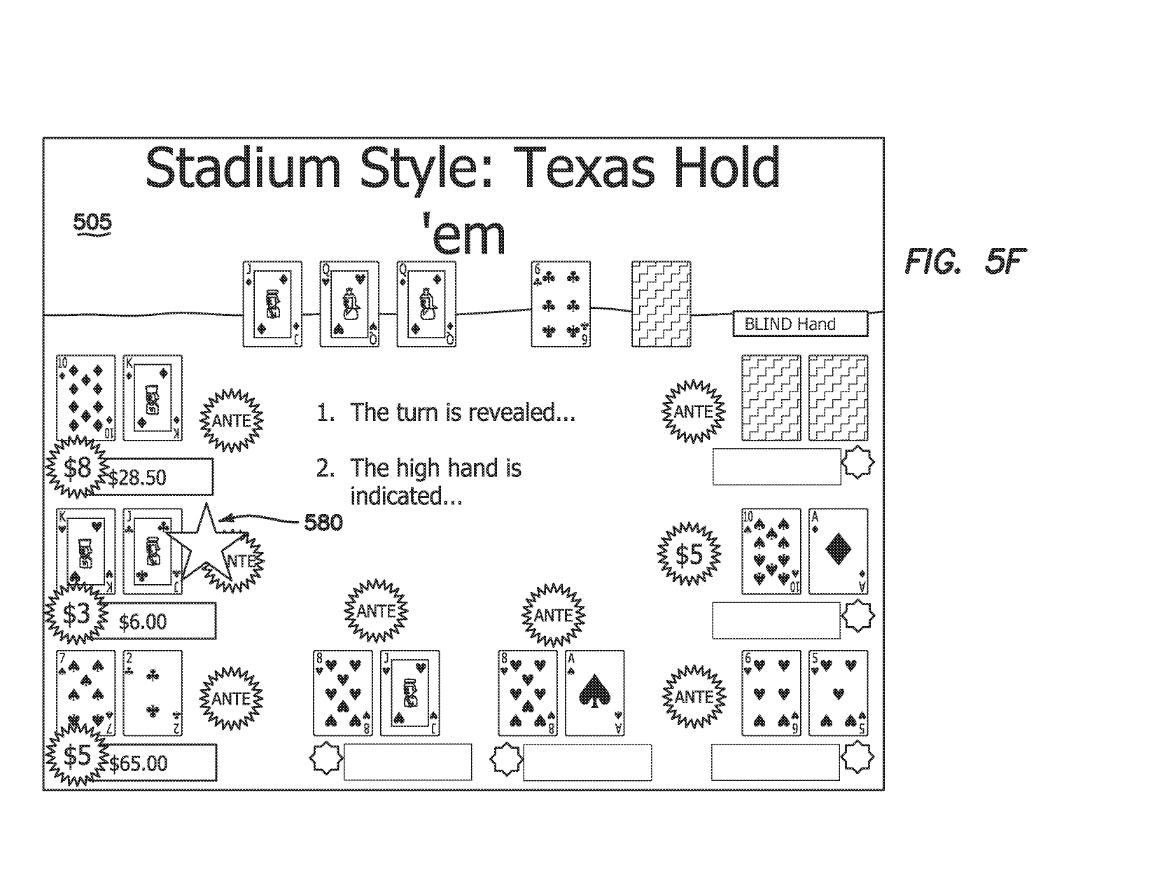

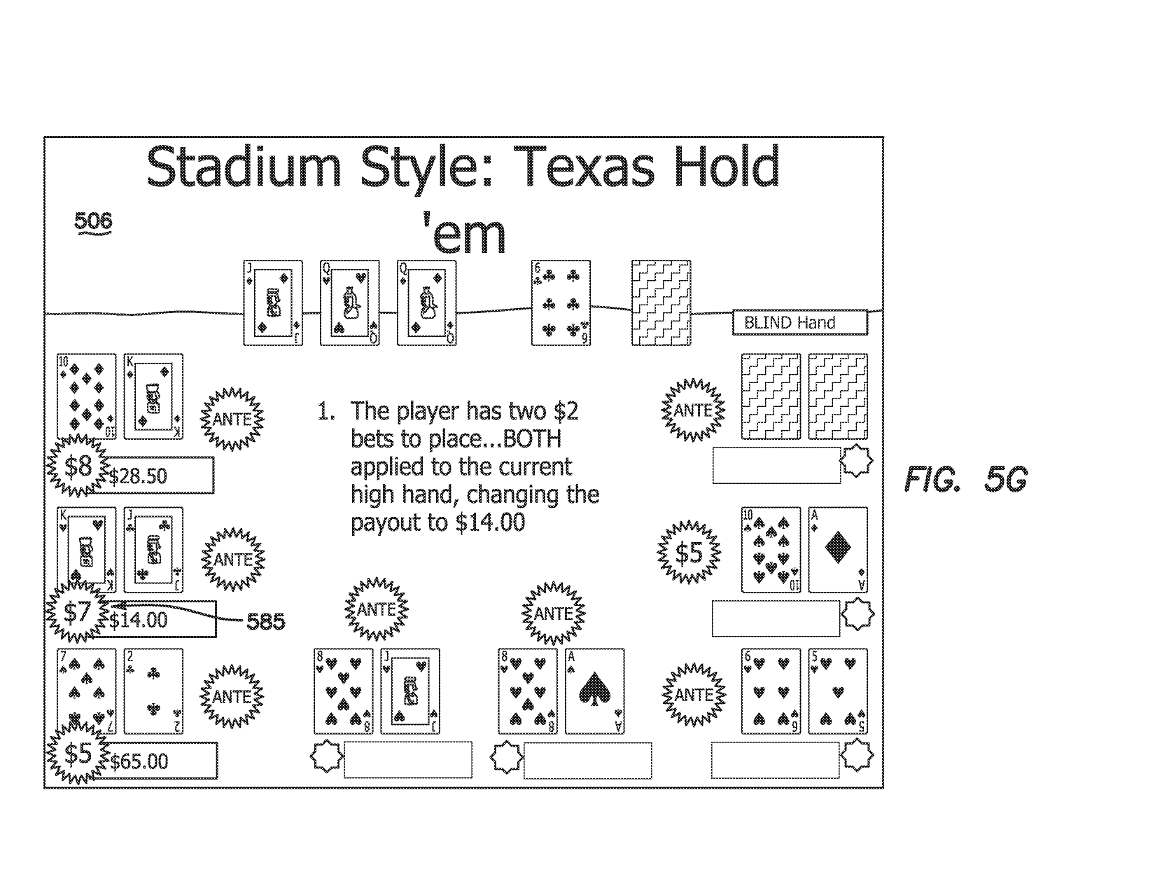

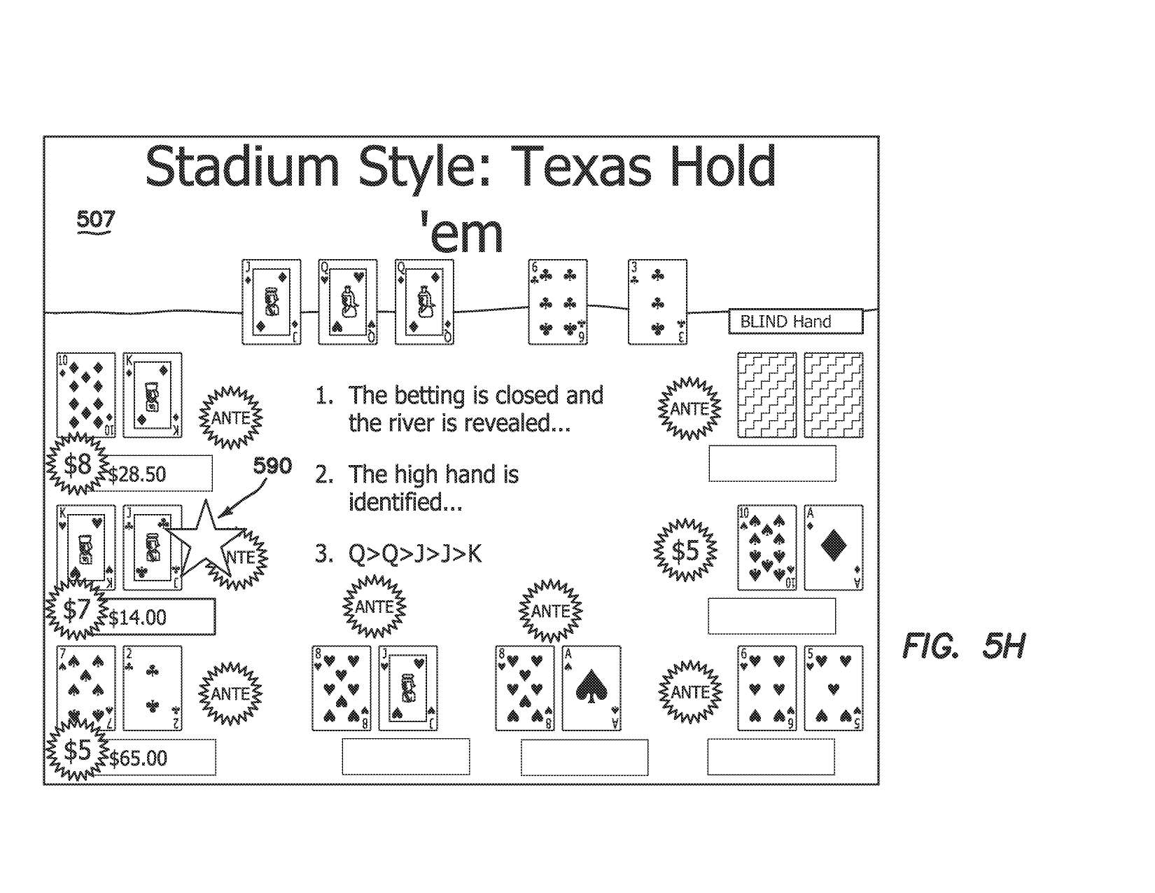

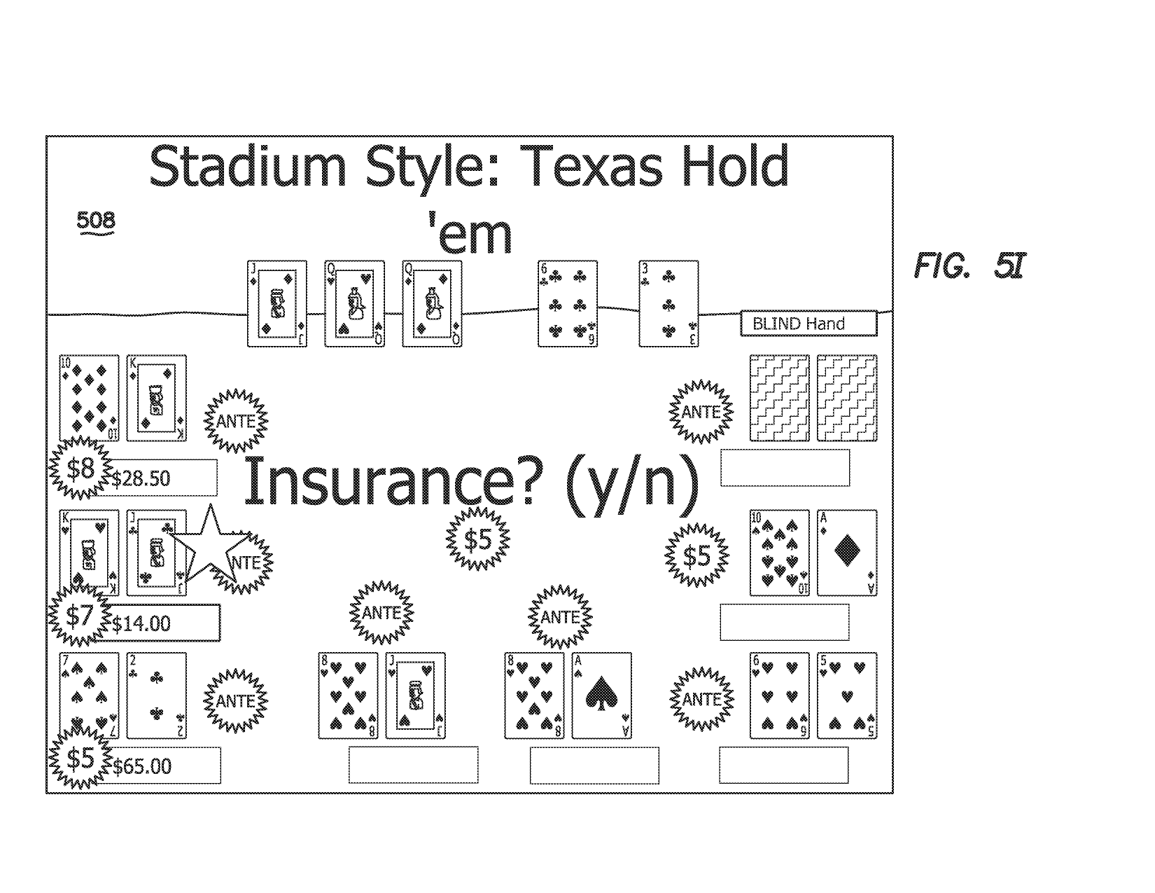

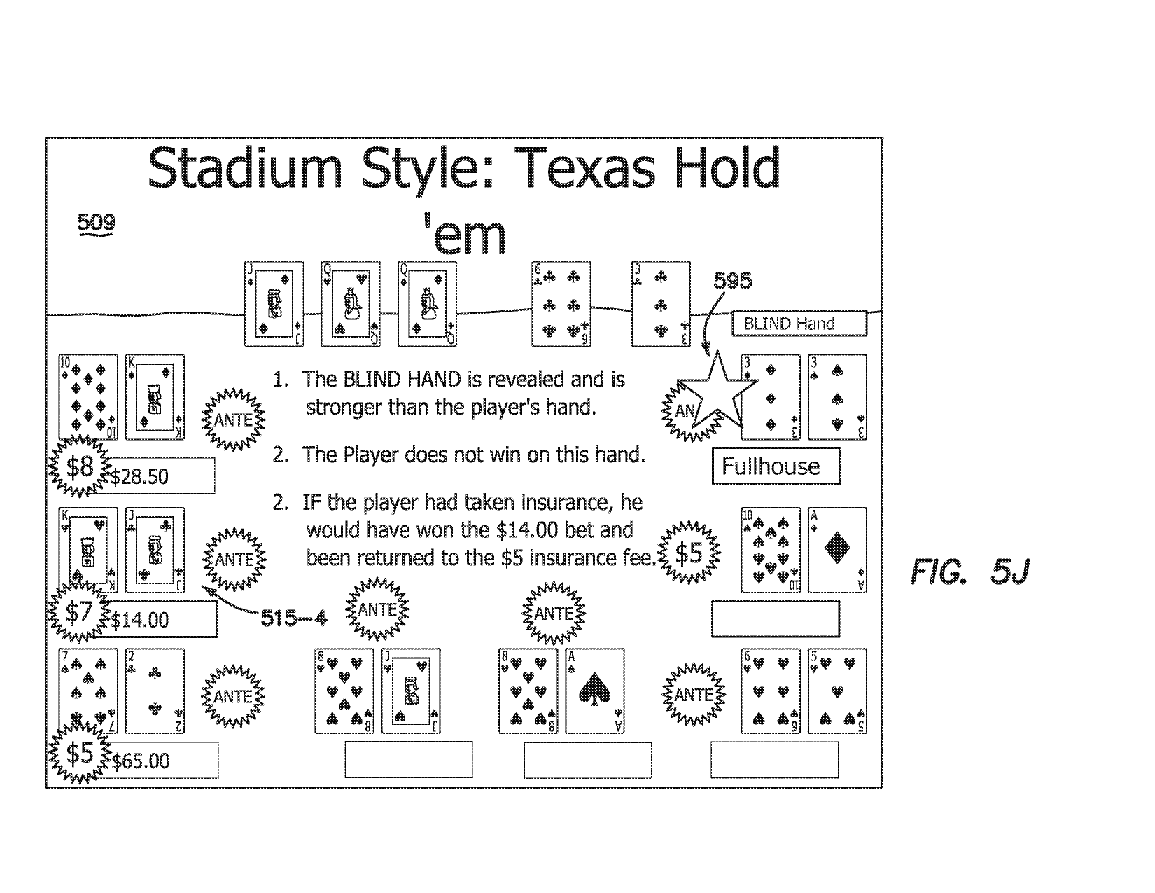

FIGS. 5A-5J illustrate screen shots of a Texas Hold' em poker game according to a third embodiment of the present invention. FIG. 5A is a screen shot 500 showing ante space 510, eight pairs of face-down, hole cards 515, along with face-down, flop cards 525, face-down, turn card 530 and face-down, river card 535. One of the eight pairs of face-down, hole cards 515-1 is identified as a blind/secret hand. From screen shot 500, the player selects one or more pairs of face-down, hole cards on which to place an ante wager. FIG. 5A shows that the player has placed a $5 ante wager 540 on the pair of hole-cards 515-2. As set forth above, the ante wager 540 is a wager on the ultimate rank of the poker hand formed with the two selected face-down hole cards 515-2 in combination with the flop cards 525, turn card 530 and river card 535. FIG. 5B is a screen shot 501 showing the hole cards 515 revealed, except for the blind/secret hand 515-1. FIG. 5B also shows corresponding hand odds and wager payouts 545. FIG. 5C is a screen shot 502 showing that the player has placed a $5 wager 550 on the pair of hole cards 515-3 comprising the 10 ♦ and K ♦ and a $5 wager 555 on the pair of hole cards 515-3 comprising the 7 [symbol] and 2 [symbol] . FIG. 5C also shows potential payouts 560-1, 560-2 representative of the wagers 550, 555. FIG. 5D is a screen shot 503 showing the three flop cards 525 revealed and a current high hand indication 565. FIG. 5E is a screen shot 504 showing the player has placed a $3 wager resulting in an $8 total wager 570 on the pair of hole cards 515-3 comprising the 10 ♦ and K ♦ and a $3 wager 575 on the pair of hole cards 515-4 comprising the K ♡ and J [symbol] . FIG. 5F is a screen shot 505 showing the turn card 530 revealed and a high hand indicator 580. FIG. 5G is a screen shot 506 showing the player has placed two $2 wagers on the same pair of hole cards 515-4 comprising the K ♡ and J [symbol] resulting in a $7 total wager 585. FIG. 5H is a screen shot 507 showing the river card 535 revealed and a high hand indicator 590 (i.e., not the winning hand yet because the blind hand 515-1 has not been revealed). FIG. 5I is a screen shot 508 showing the player being offered insurance against the blind/secret hand 515-1 being the winning hand. FIG. 5J is a screen shot 509 showing the blind/secret hand 515-1 revealed. As shown, the winning hand indicator 595 is now proximate the blind/secret hand 515-1 comprising a full house.

Therefore, the blind/secret hand 515-1 is the winning hand and all other hand wagers are lost. In one embodiment, the insurance is priced equivalent to the initial wager. If the insurance is purchased and the player wagers on the hand having the highest likelihood of winning, excluding the blind hand, and the blind hand wins, the player is returned the wagers on the hand highest having the highest likelihood of winning As shown in FIG. 5J, the player would have been returned the $14 on the hand 515-4 having the highest likelihood of winning prior to revelation of the blind/secret hand 515-1. While FIG. 5J shows that the insurance fee may be returned, in other embodiments the insurance fee is not returned under any circumstances. In one “guaranteed win insurance” embodiment, the insurance is based on a 1 to 1 ratio such that the purchase price of the insurance must equal the wager amount for the player to be guaranteed a winning wager. In this embodiment, if the insurance is not taken, the wagered upon hand must outrank the blind/secret hand to result in a winning wager.

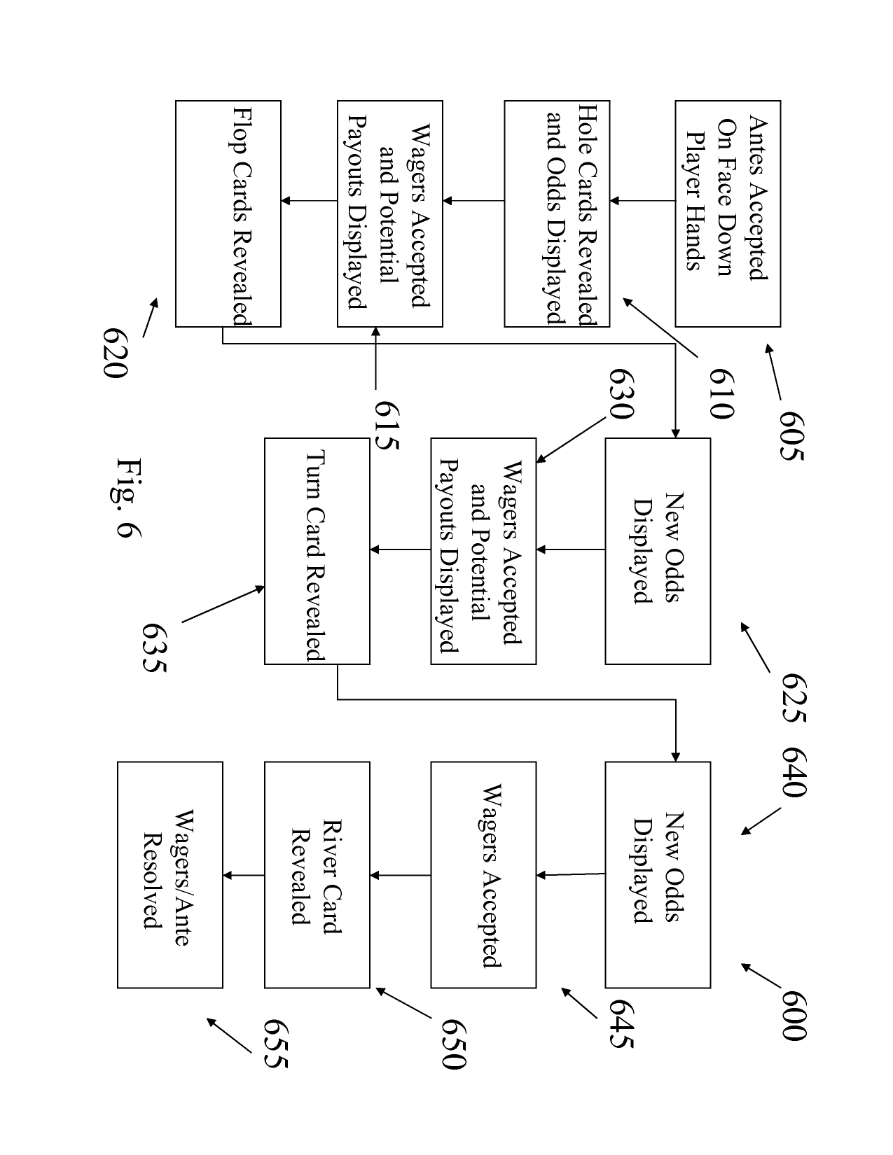

FIG. 6 shows a flow chart 600 detailing one method of conducting a Texas Hold' em game according to the embodiments of the present invention. At 605, players place ante wagers on one or more hands formed of face-down, hole cards. The ante wagers relate to the final rank of the one or more hands on which the ante wagers are placed. That is, the ante wager is paid according to a pay table based on final hand rank (not based on being the winning hand). At 610, the hole cards are revealed and winning odds and/or percentages are displayed. At 615, hand wagers/bets are accepted on one or more hands and potential payouts are displayed based on wager amounts and odds. At 620, the flop cards are revealed. At 625, new odds and/or winning percentages are displayed. At 630, hand wagers/bets are accepted on one or more hands and updated odds (adjusted given the revelation of the flop cards) and potential payouts are displayed. At 635, the turn card is revealed. At 640, new odds and/or winning percentages are displayed. At 645, hand wagers/bets are accepted on one or more hands and updated odds (adjusted given the revelation of the turn card) and potential payouts are displayed. At 650, the river card is revealed. At 655, the ante wagers and hand wagers are resolved. As detailed above, the odds and/or winning percentages associated with wagers/bets on the hands are adjusted as common cards are revealed. In this manner, each set of wagers (e.g., (i) pre-flop; (ii) post-flop and (iii) post-turn) and potential payouts are based on different, updated odds and/or winning percentages.

Although the invention has been described in detail with reference to several embodiments, additional variations and modifications exist within the scope and spirit of the invention as described and defined in the following claims.

We claim:

1. An electronically implemented method of conducting a poker game comprising:
utilizing a gaming device having a display and user interface, said gaming device communicatively linked to one or more processors running executable program instructions for:
(i) displaying on said display multiple hands comprising one or more face-up hole cards and displaying one or more face-down common cards;
(ii) accepting wagers placed via wager input means on one or more of said multiple hands responsive to player selection inputs via said user interface;
(iii) revealing on said display one or more of said face-down common cards;
(iv) repeating steps (ii) and (iii) until each of said common cards is revealed; and
(v) resolving wagers based on identification of a highest ranking poker hand among said multiple hands formed from a combination of hole cards and common cards.

2. The electronically implemented method of conducting a poker game according to claim 1 further comprising said one or more processors running executable program instructions for: accepting an ante wager on one or more of said multiple hands prior to said hole cards being revealed, said ante wager resolved based on a pay table corresponding to a final rank of one or more of said multiple hands on which the ante wager is placed.

3. The electronically implemented method of conducting a poker game according to claim 1 further comprising said one or more processors running executable program instructions for: displaying a high hand indicator throughout the poker game.

4. The electronically implemented method of conducting a poker game according to claim 1 further comprising said one or more processors running executable program instructions for: displaying one or more secret hands comprising face-down hole cards which are not revealed until each of said common cards is revealed.

5. The electronically implemented method of conducting a poker game according to claim 4 further comprising said one or more processors running executable program instructions for: providing a player the option of purchasing insurance against the one or more secret hands outranking one or more hands on which the player placed a wager.

6. The electronically implemented method of conducting a poker game according to claim 1 further comprising said one or more processors running executable program instructions for: displaying current odds or winning percentages associated with each of said multiple hands to win the poker game based on current face-up cards.

7. The electronically implemented method of conducting a poker game according to claim 1 further comprising said one or more processors running executable program instructions for: adjusting odds or winning percentages as cards are revealed.

8. An electronically implemented method of conducting a poker game comprising:
utilizing a gaming device having a display and user interface, said gaming device communicatively linked to one or more processors running executable program instructions for:
(i) displaying on said display multiple hands comprising one or more face-down hole cards and displaying one or more face-down common cards;
(ii) accepting one or more ante wagers on said one or more multiple hands comprising one or more face-down hole cards;
(iii) revealing on said display said face-down hole cards;
(iv) accepting hand wagers placed via wager input means on one or more of said multiple hands responsive to player selection inputs via said user interface;
(v) revealing on said display one or more of said face-down common cards;
(vi) repeating steps (iv) and (v) until each of said common cards is revealed;
(vii) resolving ante wagers based on a hand rank of said one or more hands on which an ante wager was placed; and
(viii) resolving hand wagers based on identification of a highest ranking poker hand among said multiple hands formed from a combination of hole cards and common cards.

9. The electronically implemented method of conducting a poker game according to claim 8 further comprising said one or more processors running executable program instructions for: displaying a high hand indicator throughout the poker game.

10. The electronically implemented method of conducting a poker game according to claim 8 further comprising said one or more processors running executable program instructions for: displaying current odds or winning percentages associated with each of said multiple hands to win the poker game based on current face-up cards.

11. The electronically implemented method of conducting a poker game according to claim 8 further comprising said one or more processors running executable program instructions for: displaying one or more secret hands comprising face-down hole cards which are not revealed until each of said common cards is revealed.

12. The electronically implemented method of conducting a poker game according to claim 11 further comprising said one or more processors running executable program instructions for: providing a player the option of purchasing insurance against the one or more secret hands outranking one or more hands on which the player placed a wager.

13. The electronically implemented method of conducting a poker game according to claim 8 further comprising said one or more processors running executable program instructions for: adjusting odds or winning percentages as cards are revealed.

14. A system for conducting a poker game comprising:
one or more gaming devices wherein each gaming device includes at least a display and user interface;
one or more processors to which said one or more gaming devices are communicatively linked, said one or more processors running executable instructions to:
(i) display on said display multiple hands comprising one or more face-up hole cards and displaying one or more face-down common cards;
(ii) accept wagers placed via wager input means on one or more of said multiple hands responsive to player selection inputs via said user interface;
(iii) reveal on said display one or more of said face-down common cards;
(iv) repeat steps (ii) and (iii) until each of said common cards is revealed; and
(v) resolve wagers based on identification of a highest ranking poker hand among said multiple hands formed from a combination of hole cards and common cards.

15. The system of conducting a poker game according to claim 14 further comprising said one or more processors running executable program instructions for: accepting an ante wager on one or more of said multiple hands prior to said hole cards being revealed, said ante wager resolved based on a pay table corresponding to a final rank of one or more of said multiple hands on which the ante wager is placed.

16. The system of conducting a poker game according to claim 14 further comprising said one or more processors running executable instructions to: display a high hand indicator throughout the poker game.

17. The system of conducting a poker game according to claim 14 further comprising said one or more processors running executable instructions to: display one or more secret hands comprising face-down hole cards which are not revealed until each of said common cards is revealed.

18. The system of conducting a poker game according to claim 17 further comprising said one or more processors running executable instructions to: provide a player the option of purchasing insurance against the one or more secret hands outranking one or more hands on which the player placed a wager.

19. The system of conducting a poker game according to claim 14 further comprising said one or more processors running executable instructions to: display current odds or winning percentages associated with each of said multiple hands to win the poker game based on current face-up cards.

20. The system of conducting a poker game according to claim 14 further comprising said one or more processors running executable program instructions for: adjusting odds or winning percentages as cards are revealed.

21. A system for conducting a poker game comprising:
one or more gaming devices wherein each gaming device includes at least a display and user interface;
one or more processors to which said one or more gaming devices are communicatively linked, said one or more processors running executable instructions to:
(i) display on said display multiple hands comprising one or more face-down hole cards and displaying one or more face-down common cards;
(ii) accept one or more ante wagers on said one or more multiple hands comprising one or more face-down hole cards;
(iii) reveal said one or more face-down hole cards;
(iv) accept hand wagers placed via wager input means on one or more of said multiple hands responsive to player selection inputs via said user interface;
(v) reveal on said display one or more of said face-down common cards;
(vi) repeat steps (iv) and (v) until each of said common cards is revealed;
(vii) resolve ante wagers based on a hand rank of said one or more hands on which an ante wager was placed; and
(viii) resolve hand wagers based on identification of a highest ranking poker hand among said multiple hands formed from a combination of hole cards and common cards.

22. The system of conducting a poker game according to claim 21 further comprising said one or more processors running executable program instructions to: display a high hand indicator throughout the poker game.

23. The system of conducting a poker game according to claim 21 further comprising said one or more processors running executable program instructions to: display current odds or winning percentages associated with each of said multiple hands to win the poker game based on current face-up cards.

24. The system of conducting a poker game according to claim 21 further comprising said one or more processors running executable program instructions to: display one or more secret hands comprising face-down hole cards which are not revealed until each of said common cards is revealed.

25. The system of conducting a poker game according to claim 21 further comprising said one or more processors running executable program instructions to: provide a player the option of purchasing insurance against the one or more secret hands outranking one or more hands on which the player placed a wager.

26. The system of conducting a poker game according to claim 21 further comprising said one or more processors running executable program instructions for: adjusting odds or winning percentages as cards are revealed.
